(19) United States
(12) Patent Application Publication
(10) Pub. No.: US 2012/0158878 A1
(43) Pub. Date: Jun. 21, 2012

(54) SERVICE PROVIDING SYSTEM, INFORMATION PROVIDING APPARATUS AND METHOD, INFORMATION PROCESSING APPARATUS AND METHOD, AND PROGRAM

(75) Inventor: Ken MIYASHITA, Kanagawa (JP)

(73) Assignee: SONY CORPORATION, Tokyo (JP)

(21) Appl. No.: 13/406,218

(22) Filed: Feb. 27, 2012

Related U.S. Application Data
(63) Continuation of application No. 10/314,235, filed on Dec. 9, 2002.

(30) Foreign Application Priority Data
Dec. 11, 2001 (JP) 2001-376944

(51) Int. Cl. G06F 15/16

(52) U.S. Cl. 709/206

(57) ABSTRACT

In a service providing system, a client computer displays chat log data received from a server in a log display area and shared information in a shared-information display area. The chat log data and the shared information, both of which are received from the server, are displayed with graphical information which supplements a relationship between the chat log data and the shared information.

### CROSS-REFERENCE TO RELATED APPLICATIONS

This application is a continuation application of, and claims the benefit of priority under 35 U.S.C. §120 from, U.S. application Ser. No. 10/314,235, filed Dec. 9, 2002, herein incorporated by reference, which claims the benefit of priority under 35 U.S.C. §119 from Japanese Patent Application No. 2001-376944, filed Dec. 11, 2001.

### BACKGROUND OF THE INVENTION

1. Field of the Invention

The present invention relates to service providing systems, information providing apparatuses and methods, information processing apparatuses and methods, and programs, and more particularly relates to a service providing system for enabling a user to communicate with other users more smoothly in a chat system, an information providing apparatus and method, an information processing apparatus and method, and a program.

2. Description of the Related Art

One service provided on the Internet is a chat system. In the chat system, text data sent from one client logged on to a server is received by the server, and the received text data is sent to another client logged on to the server. This enables a plurality of users at remote places to easily communicate with one another.

In a known chat system, the type of data that can be shared by a plurality of users is limited to text data displayed in a window in order of input. Information other than text data displayed in order of input cannot be shared by a plurality of users. A user may not be able to accurately convey desired information that the user wants to convey to another user.

### SUMMARY OF THE INVENTION

In view of the above circumstances, it is an object of the present invention to enable a plurality of users to communicate with one another more smoothly.

A service providing system of the present invention includes an information providing apparatus and a plurality of information processing apparatuses. The information providing apparatus includes a first storage unit for storing a group to which the information processing apparatuses belong; a second storage unit for storing, when first information is received from one of the information processing apparatuses, the first information in order of receipt; a third storage unit for storing, when second information differing from the first information is received from one of the information processing apparatuses, the second information; and a sending unit for simultaneously sending, when the first information or the second information is received from one of the information processing apparatuses, the received information to the remaining information processing apparatuses belonging to the same group. The information processing apparatuses each include a first providing unit for providing the first information received from the information providing apparatus to a user; and a second providing unit for providing the second information received from the information providing apparatus to the user.

An information providing apparatus of the present invention includes a first storage unit for storing a group to which information processing apparatuses belong; a second storage unit for storing, when first information is received from one of the information processing apparatuses, the first information in order of receipt; a third storage unit for storing, when second information differing from the first information is received from one of the information processing apparatuses, the second information; and a sending unit for simultaneously sending, when the first information or the second information is received from one of the information processing apparatuses, the received information to the remaining information processing apparatuses belonging to the same group.

The first information may be text data.

The second information may include at least one of text data, a graph, a table, and image data.

The information providing apparatus may further include a determining unit for determining, when the second information is received from one of the information processing apparatuses, on the basis of an identification attached to the second information for identifying the second information, whether the second information having the same identification is already stored by the third storage unit; and a storage control unit for deleting, when it is determined by the determining unit that the second information having the same identification as that of the second information received from the information processing apparatus is already stored by the third storage unit, the second information having the same identification, which has been stored by the third storage unit, from the third storage unit.

When the first information, the second information, and information linking the first information and the second information are received from one of the information processing apparatuses, the second storage unit may store the information linking the first information and the second information in conjunction with the first information. The sending unit may simultaneously send the first information, the second information, and the information linking the first information and the second information to the information processing apparatuses belonging to the same group.

An information providing method of the present invention includes a first storage step of storing a group to which information processing apparatuses belong; a second storage step of storing, when first information is received from one of the information processing apparatuses, the first information in order of receipt; a third storage step of storing, when second information differing from the first information is received from one of the information processing apparatuses, the second information; and a sending step of sending, when the first information or the second information is received from one of the information processing apparatuses, the received information to the remaining information processing apparatuses belonging to the same group.

A first program of the present invention causes a computer to perform a first storage control step of controlling storage of a group to which information processing apparatuses belong; a second storage control step of controlling, when first information is received from one of the information processing apparatuses, storage of the first information in order of receipt; a third storage control step of controlling, when second information differing from the first information is received from one of the information processing apparatuses, storage of the second information; and a sending step of sending, when the first information or the second information is received from one of the information processing apparatuses, the received information to the remaining information processing apparatuses belonging to the same group.

An information processing apparatus of the present invention includes a first providing unit for providing first information received from an information providing apparatus to a user; and a second providing unit for providing second information which is received from the information providing apparatus and which differs from the first information to the user.

The first information may be text data.

The second information may include at least one of text data, a graph, a table, and image data.

The first providing unit may provide the first information to the user in order of storage by the information providing apparatus.

The information processing apparatus may further include a determining unit for determining, in a case in which the second information is provided by the second providing unit to the user, when the second information is received from the information providing apparatus, whether an identification for identifying the received second information is the same as an identification of the second information provided by the second providing unit; and a replacing unit for replacing, when it is determined by the determining unit that the identification of the received second information is the same as the identification of the second information provided by the second providing unit, the second information provided by the second providing unit by the received second information.

The information processing apparatus may further include a first storage unit for storing the first information received from the information providing apparatus; and a second storage unit for storing the second information received from the information providing apparatus. The first providing unit may provide the first information stored by the first storage unit to the user, and the second providing unit may provide the second information stored by the second storage unit to the user.

The information processing apparatus may further include a display unit for displaying, when the first information, the second information, and information linking the first information and the second information are received from the information providing apparatus, information indicating a link between the first information provided by the first providing unit and the second providing unit on the basis of the information linking the first information and the second information.

The information indicating the link between the first information and the second providing unit may be an arrow heading from the first information towards the second providing unit.

The second providing unit may accept creation of new second information in an area for displaying the second information.

The information processing apparatus may further include a first accepting unit for accepting input of the first information; a second accepting unit for accepting a link between the first information, the input thereof being accepted by the first accepting unit, and the new second information, the creation thereof being accepted by the second providing unit; a creating unit for creating information linking the first information and the second information on the basis of the link between the first information and the second information, the link being accepted by the second accepting unit; and a sending unit for sending the first information, the input thereof being accepted by the first accepting unit, the new second information, the creation thereof being accepted by the second providing unit, and the information linking the first information and the second information to the information providing apparatus.

The second providing unit may accept addition or deletion of information to or from the second information provided by the second providing unit. When the addition or deletion of information to or from the second information provided by the second providing unit is accepted, the sending unit may send the second information to or from which the addition or deletion of information has been accepted to the information providing apparatus.

The second providing unit may display an icon in conjunction with the second information. When the icon is dragged and dropped onto an area in which the input of the first information is accepted by the first accepting unit, the second accepting unit may accept a link between the first information, the input thereof being accepted, and the second information whose icon has been dragged and dropped.

In a case in which the first accepting unit accepts input of a predetermined word, when the second information is provided by the second providing unit, the second accepting unit may accept a link between the first information, the input thereof being accepted by the first accepting unit, and the second providing unit.

An information processing method of the present invention includes a first providing step of providing first information received from an information providing apparatus to a user; and a second providing step of providing second information which is received from the information providing apparatus and which differs from the first information to the user.

A second program of the present invention causes a computer to perform a first providing step of providing first information received from an information providing apparatus to a user; and a second providing step of providing second information which is received from the information providing apparatus and which differs from the first information to the user.

According to a service providing system of the present invention, an information providing apparatus stores a group to which information processing apparatuses belong. When first information is received from one of the information processing apparatuses, the information providing apparatus stores the first information in order of receipt. When second information differing from the first information is received from one of the information processing apparatuses, the information providing apparatus stores the second information. When the first information or the second information is received from one of the information processing apparatuses, the information providing apparatus simultaneously sends the received information to the remaining information processing apparatuses belonging to the same group. The information processing apparatuses each provide the first information received from the information providing apparatus to a user and provide the second information received from the information providing apparatus to the user. Accordingly, the user can chat with other users while sharing with the other users information differing from conversation-like text exchanged in a known chat. The users can thus exchange their opinions more smoothly.

According to an information providing apparatus and method and a program of the present invention, a group to which information processing apparatuses belong is stored. When first information is received from one of the information processing apparatuses, the first information is stored in order of receipt. When second information differing from the first information is received from one of the information processing apparatuses, the second information is stored. When the first information or the second information is received from one of the information processing apparatuses, the received information is simultaneously sent to the remaining information processing apparatuses belonging to the same group. Accordingly, the user can chat with other users while sharing with the other users information differing from conversation-like text exchanged in a known chat. The users can thus exchange their opinions more smoothly.

According to an information processing apparatus and method and a program of the present invention, first information received from an information providing apparatus is provided to a user, and second information which is received from the information providing apparatus and which differs from the first information is provided to the user. Accordingly, the user can chat with other users while sharing with the other users information differing from conversation-like text exchanged in a known chat. The users can thus exchange their opinions more smoothly.

### BRIEF DESCRIPTION OF THE DRAWINGS

FIG. 1 is a diagram showing the configuration of a chat system according to an embodiment of the present invention;

FIG. 2 is a block diagram showing an example of the configuration of a server 2 shown in FIG. 1;

FIG. 3 is a block diagram showing an example of the configuration of a client computer 3 shown in FIG. 1;

FIG. 4 is a flowchart describing a process of starting a chat in the chat system shown in FIG. 1;

FIG. 5 illustrates an example of an image displayed on a monitor 71 of a client computer 3-1 in step S14 shown in FIG. 4;

FIG. 6 is a flowchart describing a process of inputting chat text in the chat system shown in FIG. 1;

FIG. 7 is a flowchart describing a process of displaying shared information in the chat system shown in FIG. 1;

FIG. 8 illustrates an example of an image displayed on the monitor 71 of the client computer 3-1 in step S72 shown in FIG. 7;

FIG. 9 illustrates another example of an image displayed on the monitor 71 of the client computer 3-1 in step S72 shown in FIG. 7;

FIG. 10 illustrates an example of an image displayed on the monitor 71 of the client computer 3-1 in step S75 shown in FIG. 7;

FIG. 11 illustrates an example of an image displayed on a monitor 71 of a client computer 3-2 in step S82 shown in FIG. 7;

FIG. 12 illustrates an example of an image displayed on the monitor 71 of the client computer 3-2 performing chatting;

FIG. 13 illustrates an example of an image displayed, subsequent to that shown in FIG. 12, on the monitor 71 of the client computer 3-2 performing chatting;

FIG. 14 illustrates an example of an image displayed, subsequent to that shown in FIG. 13, on the monitor 71 of the client computer 3-2 performing chatting;

FIG. 15 schematically illustrates the structure of information management using a database.

FIG. 16 illustrates an example of an image displayed on a monitor 71 of a client computer 3-3;

FIG. 17 is a flowchart describing a process of displaying shared information while three client computers are chatting with one another;

FIG. 18 illustrates an example of an image displayed on the monitor 71 of the client computer 3-3 in step S164 shown in FIG. 17;

FIG. 19 illustrates an example of an image displayed on the monitor 71 of the client computer 3-1;

FIG. 20 illustrates another example of an image displayed on the monitor 71 of the client computer 3-1;

FIG. 21 is a flowchart describing a process performed by the server for managing chatting;

FIG. 22 is a flowchart describing a process performed by the client computer for managing chatting;

FIG. 23 is a flowchart continued from that shown in FIG. 22;

FIG. 24 is a flowchart describing a process of placing a link from chat text to a shared-information window.

### DESCRIPTION OF THE PREFERRED EMBODIMENTS

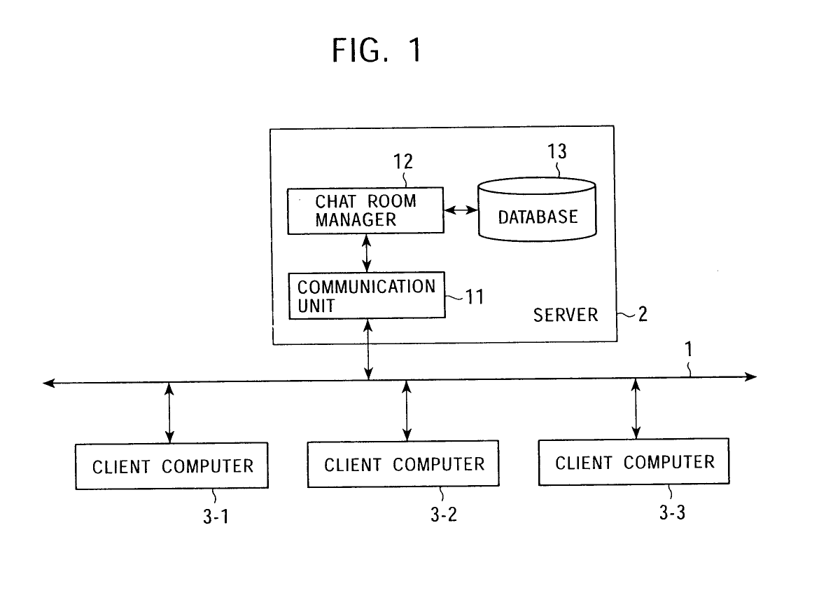

FIG. 1 shows the configuration of a chat system according to an embodiment of the present invention. The chat system is primarily formed of chat clients and a chat server for performing chatting.

Specifically, referring to FIG. 1, a server 2 is connected via a communication unit 11 to a network 1 such as the Internet. Three client computers 3-1 to 3-3 are connected to the network 1.

The server 2 is formed of, for example, a workstation, a personal computer, or the like and functions as a chat server by executing a chat server program.

More specifically, the server 2 stores text data input from the client computers 3-1 to 3-3 (hereinafter referred to as chat text) as chat log data in a database 13 in order of input. Also, the server 2 stores data which is input from the client computers 3-1 to 3-3 to be shared with the client computers 3-1 to 3-3 and which differs from the chat log data as shared information in the database 13.

The server 2 reflects the chat log data and the shared information stored in the database 13 in images displayed by the client computers 3-1 to 3-3. A chat room manager 12 manages the database 13. Accordingly, the server 2 provides a chat environment in which the client computers 3-1 to 3-3 communicate with one another.

The client computers 3-1 to 3-3 (hereinafter generally referred to as the “client computer(s) 3” when it is unnecessary to make distinction among the client computers 3-1 to 3-3) each store a chat client program for performing chatting while sharing a chat space provided by the server 2 with the other computers 3. By execution of the chat client program and the chat server program in the server 2, the client computer 3 displays the chat space for performing chatting.

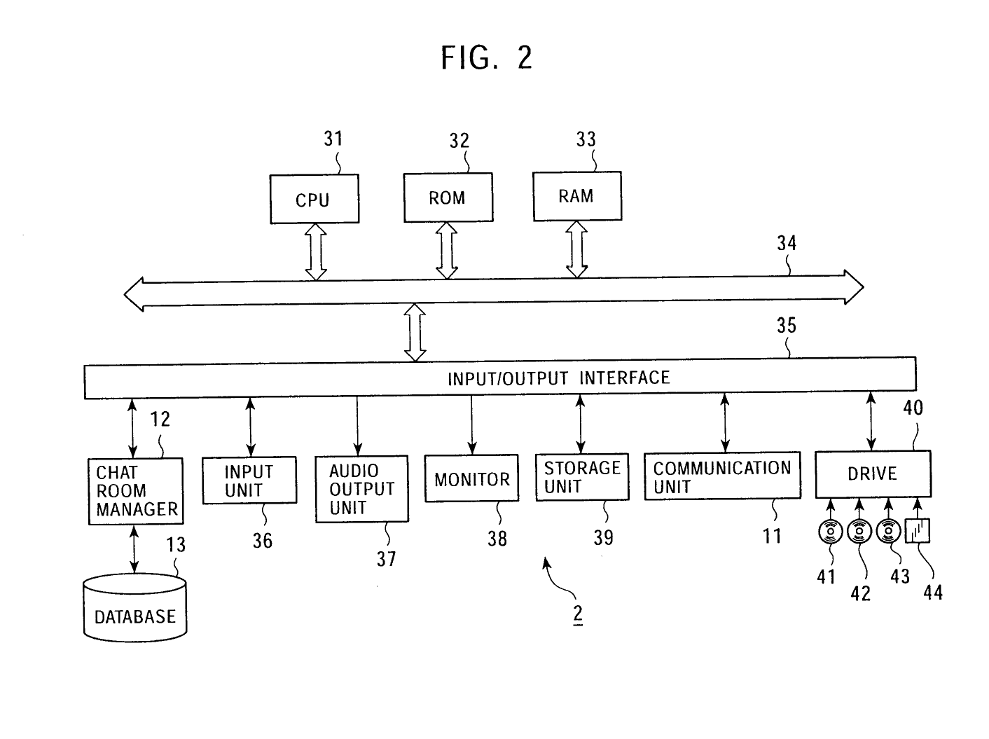

FIG. 2 shows an example of the configuration of the server 2. A ROM (Read Only Memory) 32 stores programs used by a CPU (Central Processing Unit) 31 and basically-fixed data of calculation parameters. The CPU 31 executes various application programs and a basic OS (Operating System) program to perform various processes described below. A RAM (Random Access Memory) 33 stores programs executed by the CPU 31 and data required for the processing by the CPU 31.

The CPU 31, the ROM 32, and the RAM 33 are interconnected by a bus 34. An input/output interface 35 is connected to the bus 34.

The chat room manager 12, an input unit 36, an audio output unit 37, a monitor 38, a storage unit 39, and the communication unit 11 are connected to the input/output interface 35. If necessary, a drive 40 is connected to the input/output interface 35.

In response to reception of an instruction to create a new chat room from the client computer 3, the chat room manager 12 creates a region, in the database 13, for managing data exchanged in the new chat room from this point onward. A chat room ID for identifying the chat room is assigned to the region.

In the region created for the new chat room, a region for managing chat log data and a region for managing shared information are created. Subsequently, the chat log data and the shared information are managed in the respective regions.

In the following description, the region for managing the chat log data is referred to as the chat log data management region, and the region for managing the shared information is referred to as the shared information management region.

In response to reception of chat text from the client computer 3 performing chatting, the chat room manager 12 searches the database 13 on the basis of the chat room ID sent in conjunction with the chat text for the corresponding chat room. The chat room manager 12 stores the received chat text as chat log data in the chat log data management region in the chat room.

If chat log data is already stored in the chat log data management region, the chat room manager 12 adds the received chat text to the already-stored chat log data and updates the stored data.

If the chat text received from the client computer 3 includes a shared information ID (ID for identifying individual pieces of shared information, which will be described later) attached thereto, the chat room manager 12 attaches the shared information ID included in the chat text to the chat log data and stores the chat log data with the shared information ID in the chat log data management region.

After the chat room manager 12 stores the received chat text as the chat log data in the database 13, the chat room manager 12 sends the chat log data stored in the database 13 to all client computers 3 chatting in the same chat room via the communication unit 11.

Of the chat log data, only a portion that corresponds to the received chat text is sent. When the chat log data includes the shared information ID attached thereto, the chat room manager 12 also sends the shared information ID in conjunction with the chat log data via the communication unit 11.

When the chat room manager 12 receives shared information from the client computer 3 performing chatting, the chat room manager 12 searches the database 13 on the basis of the chat room ID sent in conjunction with the shared information for the corresponding chat room. The chat room manager 12 stores the received shared information in the shared information management region corresponding to the chat room ID in the database 13.

If shared information having the same shared information ID is already stored in the shared information management region in the database 13, the chat room manager 12 deletes the shared information with the same shared information ID, which has been stored in the shared information management region, in the database 13, and stores the newly received shared information.

After the chat room manager 12 stores the shared information in the shared information management region, the chat room manager 12 sends the stored shared information to all the client computers 3 belonging to the chat room via the communication unit 11.

The chat room manager 12 individually identifies and manages each member logged on to the chat room. When a new user logs on to the chat in progress, or when a user logs out from the chat, the chat room manager 12 updates information concerning members logged on to the chat room (hereinafter referred to as logged-on user information) and sends the updated logged-on user information to all the client computers 3 logged on to the chat room.

The input unit 36 is formed of, for example, a keyboard and a mouse and operated by a user when inputting various commands to the CPU 31. Under the control of the CPU 31, the audio output unit 37 plays predetermined audio data. The monitor 38 is formed of, for example, a CRT (Cathode-Ray Tube) or an LCD (Liquid Crystal Display) and displays predetermined information under the control of the CPU 31. The storage unit 39 stores, for example, the OS and the chat client program supplied to each client computer 3.

The communication unit 11 performs communication processing via the network 1 with the client computers 3.

If necessary, the drive 40 is connected to the input/output interface 35. A magnetic disk 41, an optical disk 42, a magneto-optical disk 43, or a semiconductor memory 44 is placed on the drive 40 as the need arises, and a computer program read therefrom is installed in the storage unit 39 if necessary.

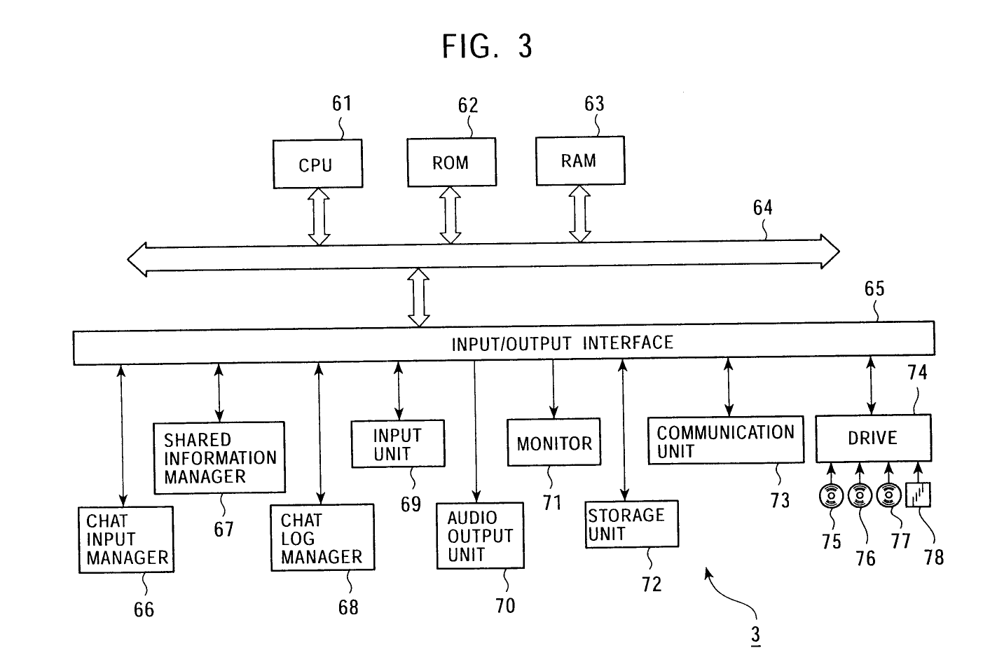

FIG. 3 shows an example of the configuration of the client computer 3 shown in FIG. 1. As shown in FIG. 3, the client computer 3 is arranged by removing the chat room manager 12 and the database 13 from the internal configuration of the server 2 shown in FIG. 2 and, instead, adding a chat input manager 66, a shared information manager 67, and a chat log manager 68. The chat input manager 66, the shared information manager 67, and the chat log manager 68 will now be described, and a description of the common portion with the server 2 is omitted.

In the following description, a window for displaying chat log data input from users in order of input (a known window for chatting) is referred to as a chat window. A window for displaying shared information and for accepting addition and/or deletion of information by users is referred to as a shared-information window.

The chat input manager 66 performs predetermined processing on chat text input at a predetermined position (input area) in the chat window via the input unit 69 and sends the processed chat text via a communication unit 73 to the server 2.

When an operation is performed to link the chat text input in the input area with the shared-information window, the chat input manager 66 adds a predetermined character string to the chat text being input and displays an arrow indicating a link between the chat text and the shared-information window on a monitor 71. Subsequently, when an instruction to send the chat text is input from the input unit 69, the chat input manager 66 attaches a shared information ID (details thereof are described later) to the chat text to be sent to the server 2 and sends the chat text to the server 2.

When information created in the shared-information window is designated by a user to be shared with the other client computers 3, the shared information manager 67 creates a shared information ID for individually identifying each piece of shared information, attaches the created shared information ID to the shared information, and sends the shared information via the communication unit 73 to the server 2.

When the shared information manager 67 receives shared information from the server 2 via the communication unit 73, the shared information manager 67 stores the received shared information in a storage unit 72.

If shared information having the same shared information ID is already stored in the storage unit 72, the shared information manager 67 deletes the shared information with the same shared information ID, which has been stored in the storage unit 72, and stores the newly received shared information.

Subsequently, the shared information manager 67 displays the shared information stored in the storage unit 72 in the shared-information display window.

The chat log manager 68 stores chat log data supplied from the server 2 in the storage unit 72, subsequently displays the chat window on the monitor 71, and displays the chat log data in the chat window. If the chat log data supplied from the server 2 includes a shared information ID attached thereto, the chat log manager 68 additionally stores the shared information ID in the storage unit 72.

In a case in which chat log data is already stored in the storage unit 72, if additional chat log data is supplied from the server 2, the chat log manager 68 adds the received chat log data to the chat log data stored in the storage unit 72 and stores the chat log data. The chat log manager 68 additionally displays the stored chat log data in the chat window.

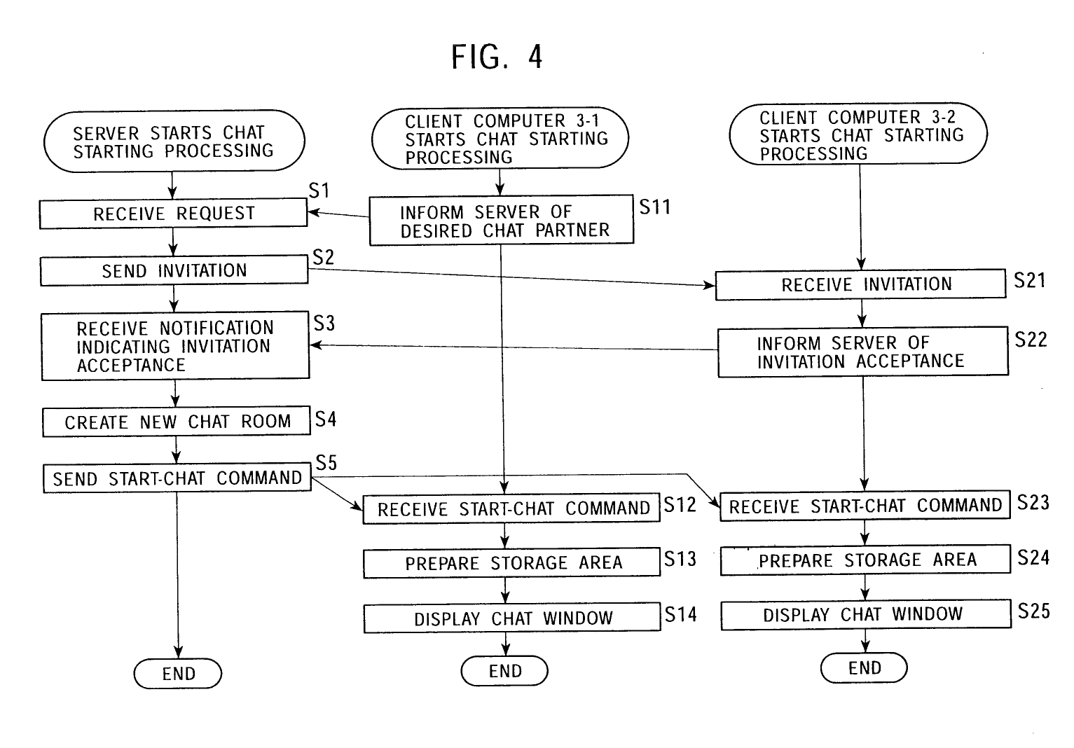

With reference to the flowchart of FIG. 4, a process of starting a chat will now be described.

In the following description, a user using the client computer 3-1 is referred to as user A; a user using the client computer 3-2 is referred to as user B; and a user using the client computer 3-3 is referred to as user C. The nickname of user A is “AAA”; the nickname of user B is “BBB”; and the nickname of user C is “CCC”.

In the following description, references are made to examples of images displayed on the monitor 71 of each client computer 3. The same reference number is given to those corresponding to the same portion in a plurality of drawings.

The server 2 is activated. The server 2 constantly detects the client computer(s) 3 connected to the network 1.

When user A activates the client computer 3-1, a client program for managing the chat system is activated in the client computer 3-1. The operation of the client program causes the client computer 3-1 to display, at a predetermined position on the monitor 71, a list of client computers 3 activated and connected to the network 1 at that time from among the remaining client computers 3 (hereinafter referred to as a user list).

In step S11 of FIG. 4, user A operates the operation unit 69 of the client computer 3-1 and designates a desired chat partner (user B in this case) from the user list displayed on the monitor 71. On the basis of the designation by the user, the client computer 3-1 sends the nickname “BBB” of user B designated as the desired chat partner and the name of a chat room into which the desired chat partner is invited (“AAA” in this case) to the server 2 and requests the server 2 to send an invitation to a chat to user B.

In step S1, the server 2 receives the request sent from the client computer 3-1 in step S11.

In step S2, the server 2 sends an invitation indicating that there is the chat invitation to the chat room “AAA” from user A to the client computer 3-2.

In step S21, the communication unit 73 of the client computer 3-2 receives the invitation sent from the server 2 in step S2 and displays the invitation on the monitor 71. At this time, a guidance message such as “You have received an invitation to a chat from AAA. Do you want to participate in the chat? (YES or NO)” is displayed.

When user B selects “NO”, the client computer 3-2 sends a negative response to the server 2. The server 2 informs the client computer 3-1 of the negative response that user B does not want to participate in the chat.

In contrast, when user B selects “YES”, the client computer 3-2 sends in step S22 an affirmative response that user B wants to participate in the chat via the communication unit 73 to the server 2.

In step S3, the server 2 receives the response from the client computer 3-2 given in step S22.

In step S4, the chat room manager 12 of the server 2 creates a region for storing data to be exchanged between the client computers 3-1 and 3-2 in a new chat room in the database 13 and assigns a chat room ID to the created region. The chat room manager 12 creates logged-on user information indicating that user A and user B are logged on to the new chat room and stores the logged-on user information in the region with the chat room ID.

In step S5, the server 2 sends start-chat commands to the client computers 3-1 and 3-2.

In step S12, the communication unit 72 of the client computer 3-1 receives the command sent from the server 2 in step S5. In step S13, the CPU 61 of the client computer 3-1 creates, in the storage unit 72, a region for storing data to be exchanged in the chat room from this point onward.

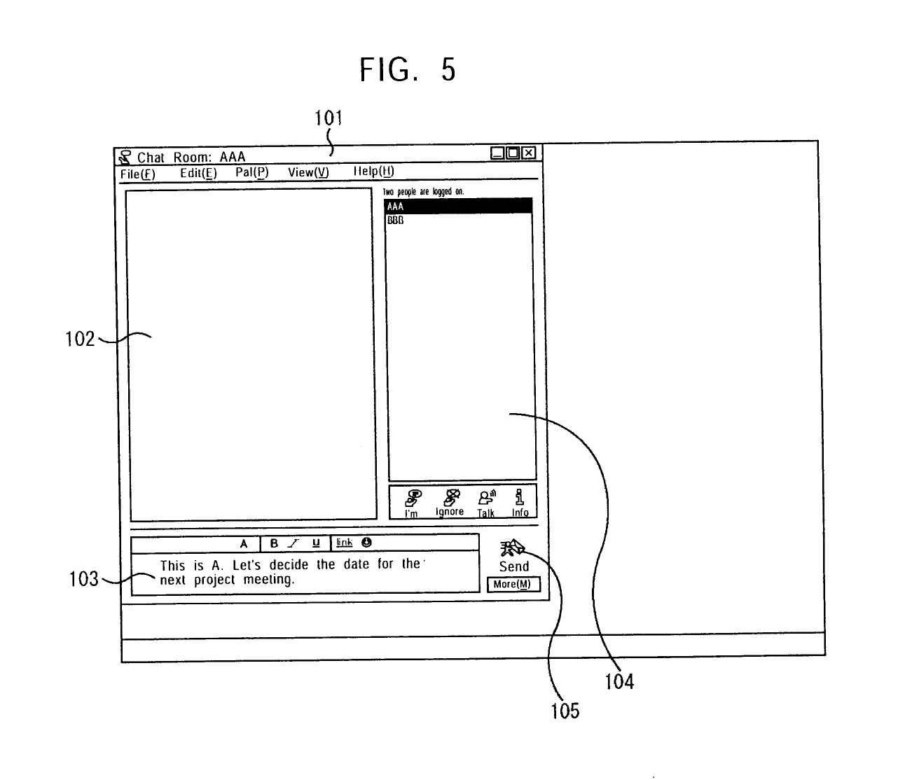

In step S14, the CPU 61 of the client computer 3-1 displays a chat window at a predetermined position on the monitor 71. FIG. 5 shows an example of an image displayed on the monitor 71 of the client computer 3-1.

Referring to FIG. 5, a chat window 101 is displayed at the left side of the monitor 71. The chat window 101 is formed of a log display area 102, an input area 103, and a user-list display area 104.

The input area 103 accepts input of a character string from a user. In step S14, no character is input in the input area 103. The log display area 102 displays chat log data. The user-list display area 104 displays a list of users (nicknames) who are owners of the client computers 3 connected to the network 1 from among the client computers 3.

When a send key 105 is clicked, the chat text input in the input area 103 is sent to the server 2.

In step S23, the communication unit 73 of the client computer 3-2 receives the command sent from the server 2 in step S5. In step S24, the CPU 61 of the client computer 3-2 creates, in the storage area 72, a region for storing data to be exchanged in the chat room from this point onward.

In step S25, the CPU 61 of the client computer 3-2 displays a chat window at a predetermined position on the monitor 71. As in the client computer 3-1, the monitor 71 of the client computer 3-2 displays the chat window including a log display area, an input area, and a user-list display area.

As discussed above, the new chat room starts to be shared by user A and user B. Alternatively, a chat can be started without performing the above-described process. In the above description, an invitation is sent to only user B. Alternatively, invitations can be sent to a plurality of users.

When sending invitations to a plurality of users, in step S11, user A selects the nicknames of all desired chat partners and sends the nicknames to the server 2. The server 2 sends invitations to all the users requested by the client computer 3-1 and sends start-chat commands to all the client computers 3 that have given invitation acceptance responses.

Accordingly, a chat can be started among a plurality of users.

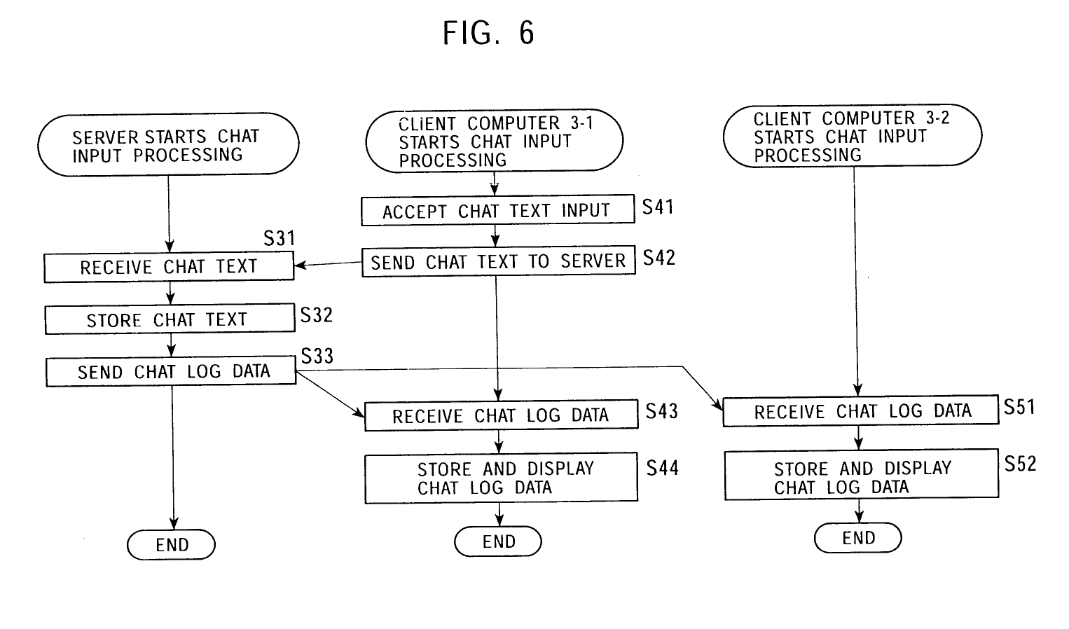

Referring to FIG. 6, a process of accepting chat text input and displaying chat log data will now be described.

In step S41, the client computer 3-1 accepts chat text input from user A via the input unit 69. Specifically, for example, the input area 103 of the monitor 71 of the client computer 3-1 accepts input of chat text (“This is A. Let's decide the date for the next project meeting” in FIG. 5). When the mouse clicks on the send key 105 to designate sending, the process proceeds to step S42.

In step S42, the chat input manager 66 of the client computer 3-1 sends the chat text input in the input area 103 (“This is A. Let's decide the date for the next project meeting” in FIG. 5) via the communication unit 73 to the server 2.

When the send key 105 is clicked, the shared information manager 67 determines whether or not there is shared information to be sent. In FIG. 5, no shared information is created. It is thus determined that there is no shared information to be sent. The shared information manager 67 does not send shared information to the server 2.

In step S31, the communication unit 11 of the server 2 receives the chat text sent from the client computer 3-1 in step S42. In step S32, the chat room manager 12 of the server 2 stores the received chat text as chat log data in the region created in the database 13 in step S4 of FIG. 4.

In step S33, the chat room manager 12 of the server 2 sends the chat log data stored in the database 13 in step S32 via the communication unit 11 to the client computers 3-1 and 3-2.

In step S43, the communication unit 73 of the client computer 3-1 receives the chat log data sent from the server 2 in step S33.

In step S44, the chat log manager 68 of the client computer 3-1 stores the chat log data received in step S43 in the storage unit 72 and displays the chat log data in the log display area 102 of the chat window 101. For example, referring to FIG. 5, the log display area 102 displays the nickname “AAA” of user A and the chat log data “This is A. Let's decide the date for the next project meeting”. At this time, the chat text input in the input area 103 is deleted.

In steps S51 and S52, the client computer 3-2 performs processing similar to that performed by the client computer 3-1 in step S43 and S44. As a result, as in the client computer 3-1, the chat log data is also displayed in the log display area of the monitor 71 of the client computer 3-2.

Accordingly, the chat log data is shared among a plurality of users.

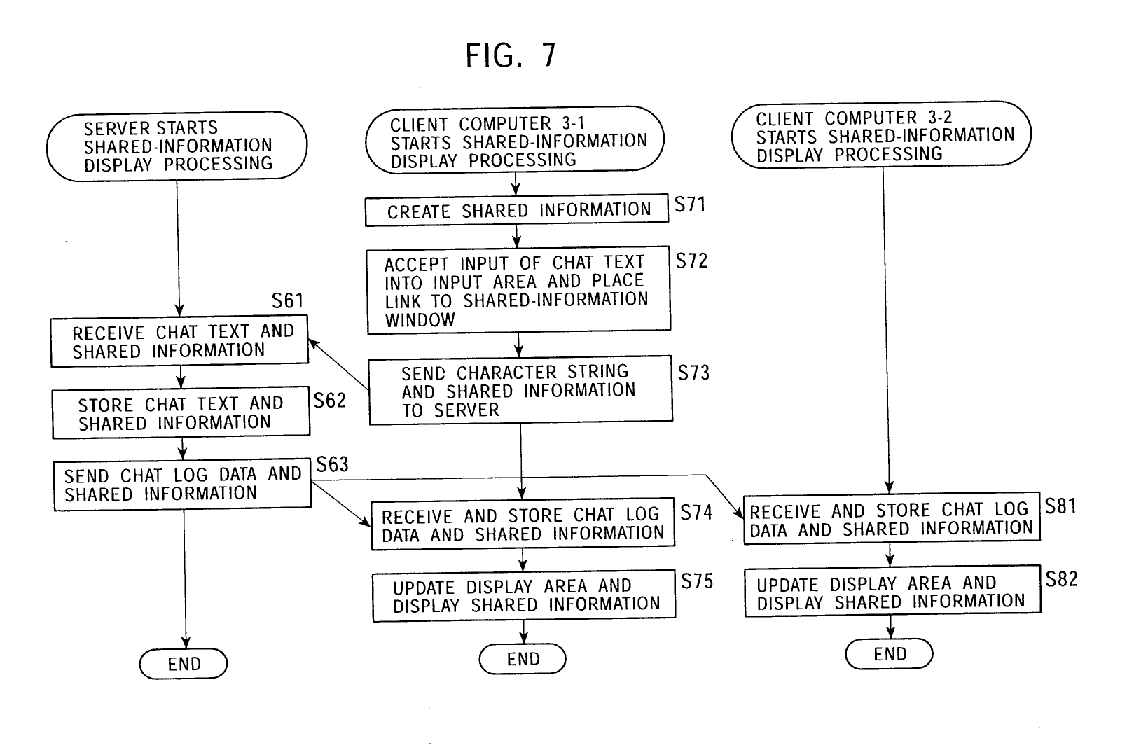

Referring to the flowchart of FIG. 7, a process of enabling a plurality of client computers to share shared information will now be described.

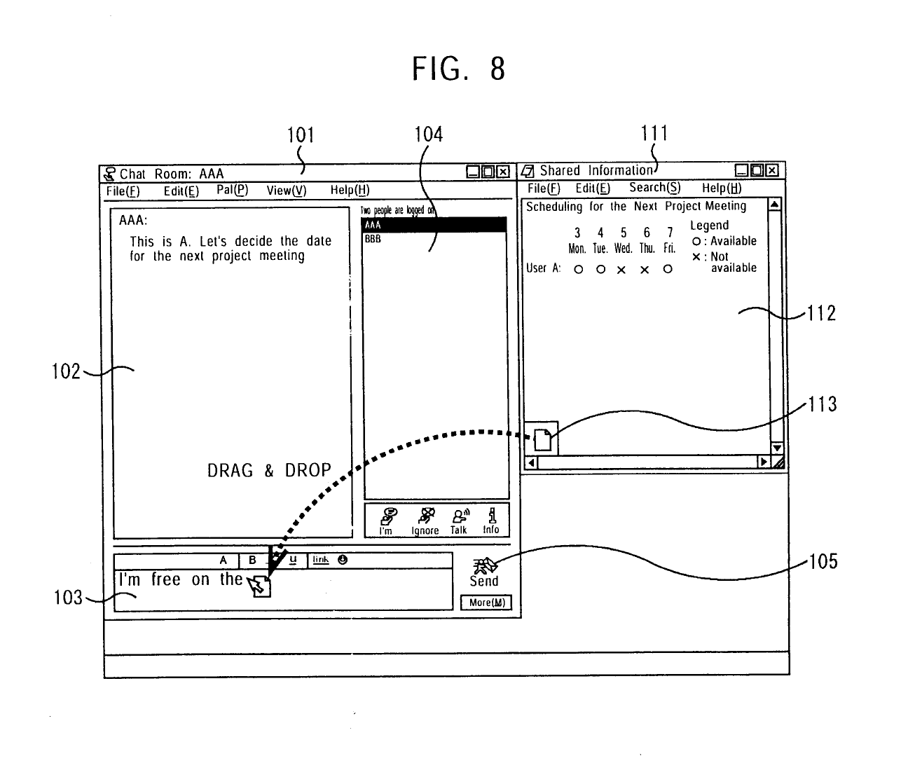

In step S71, in response to an instruction from user A via the input unit 69, the shared information manager 67 of the client computer 3-1 displays a shared-information window 111 on the monitor 71, as shown in FIG. 8. FIG. 8 shows an example of a screen displayed on the monitor 71 of the client computer 3-1 subsequent to the process shown in FIG. 7. User A writes information that user A wants to share with the other users in a shared-information display area 112 of the displayed shared-information window 111.

User A can freely write various types of data, such as characters, images, tables, and graphs, in the shared-information display area 112 of the shared-information window 111. Referring to FIG. 8, the character string “Scheduling for the Next Project Meeting” and the schedule of user A from the third (Monday) through the seventh (Friday) are written using the symbols ◯ and x (◯ means that the user is available and x means that the user is not available).

In step S72, the client computer 3-1 accepts the input of chat text into the input area 103 from user A and a link between the chat text input in the input area 103 and the shared-information window 111.

Specifically, for example, referring to FIG. 8, when user A inputs the chat text “I′m free on the” in the input area 103 and drags-and-drops a shared-information icon 113 displayed in the lower left hand corner of the shared-information window 111 onto the input area 103, a link is placed between the character string being input in the input area 103 and the shared-information window 111. In FIG. 8, a dotted line indicating the drag-and-drop operation is not actually displayed on the monitor 71.

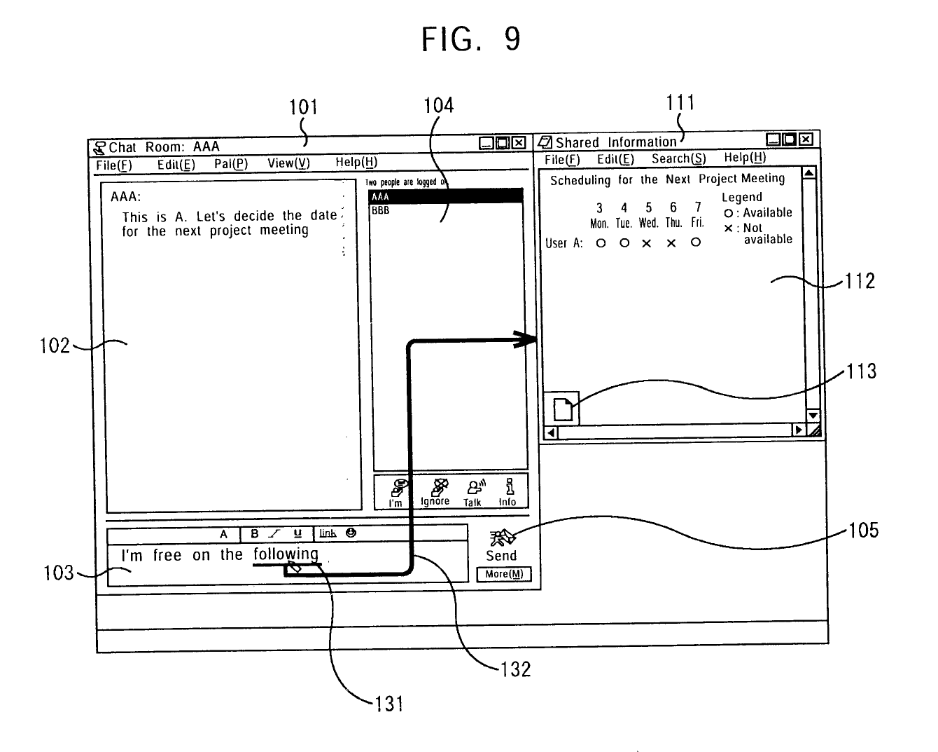

FIG. 9 shows an example of an image displayed on the monitor 71 immediately after the shared-information icon 113 is dragged and dropped onto the input area 103.

Referring to FIG. 9, the word “following”, which is a link word 131, is displayed subsequent to the character string “I′m free on the” being input in the input area 103, and a link arrow 132 heading from the link word 131 towards the linked shared-information window 111 is displayed.

As discussed above, when the shared-information icon 113 is dragged and dropped onto the input area 103, the chat input manager 66 adds the link word 131 “following” at the end of the chat text and displays the link arrow 132 heading from the link word 131 towards the shared-information window 111 on the monitor 71.

In the above description, after the shared information is completely written in the shared-information display area 112 in step S71, a link to the shared-information window 111 is placed in step S72. Alternatively, after a link to the shared-information window 111 is placed, information is written in the shared-information display area 112.

Subsequent to the chat text “I′m free on the following” being input in the input area 103, “days” is input. Subsequently, when user A clicks on the send key 105, the process proceeds to step S73.

In step S73, the shared information manager 67 of the client computer 3-1 creates a shared information ID of the shared information written in the shared-information display area 112 and attaches the shared information ID to the shared information. Also, the shared information manager 67 supplies the shared information ID to the chat input manager 66. The chat input manager 66 attaches the shared information ID to the chat text “I′m free on the following days”. The chat room ID is attached to the shared information having the shared information ID attached thereto by the shared information manager 67 and to the chat text having the shared information ID attached thereto by the chat input manager 66, and the shared information and the chat text are sent via the communication unit 73 to the server 2.

In step S61, the communication unit 11 of the server 2 receives the chat text and the shared information sent from the client computer 3-1 in step S73.

In step S62, the chat room manager 12 of the server 2 searches the database 13 for the storage region having the same chat room ID as that attached to the received data and stores the received chat text “I′m free on the following days.” as chat log data having the shared information ID attached thereto in the detected chat log data management region.

The chat room manager 12 reads the shared information ID attached to the shared information received in step S61 and determines whether or not shared information having the same shared information ID is stored in the shared information management region. If there is shared information having the same shared information ID, the chat room manager 12 deletes the shared information with the same shared information ID from the shared information management region in the database 13 and stores the shared information received in step S61. In this example, it is determined that no shared information having the same shared information ID is stored. In this case, the chat room manager 12 stores the shared information (having the shared information ID attached thereto) received in step S61 in the shared information management region.

In this case, the chat log data “I′m free on the following days.” is stored in conjunction with the previously-stored chat log data “This is A. Let's decide the date for the next project meeting”. The two pieces of chat log data are arranged and stored in order of storage.

In step S63, the chat room manager 12 of the server 2 sends the chat log data “I′m free on the following days.” and the shared information stored in the database 13 in step S62 via the communication unit 11 to the client computers 3-1 and 3-2.

In step S74, the communication unit 73 of the client computer 3-1 receives the chat log data and the shared information sent from the server 2 in step S63. The CPU 61 of the client computer 3-1 stores the received chat log data and the shared information in the storage unit 72.

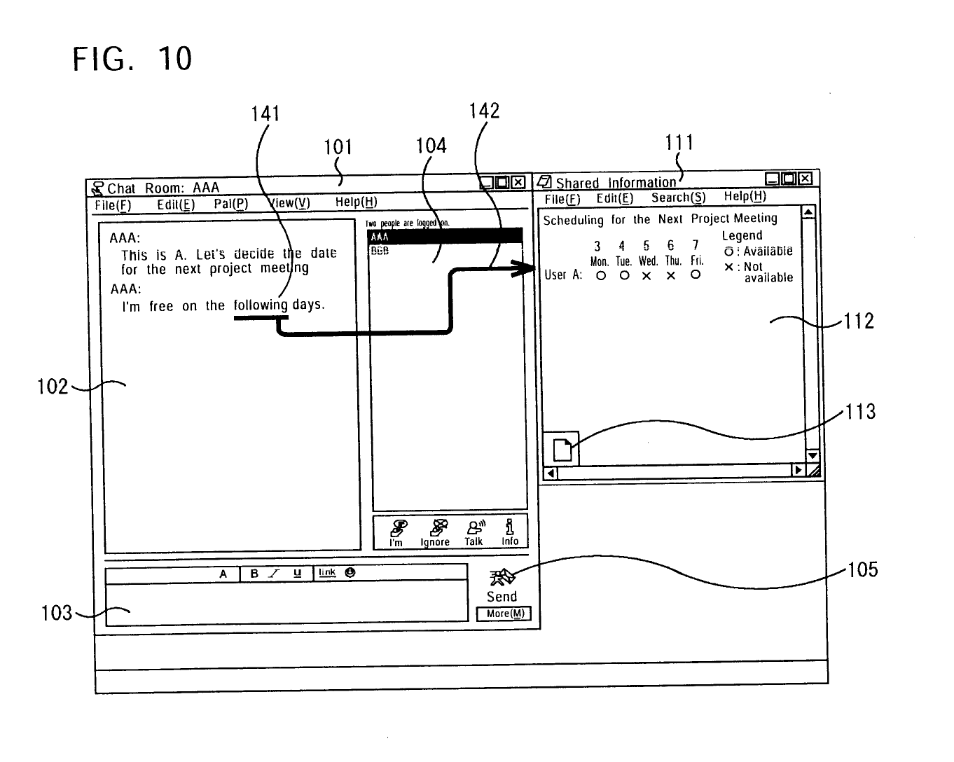

In step S75, as shown in FIG. 10, the chat log manager 68 of the client computer 3-1 displays the chat log data stored in the storage unit 72 in step S74 in the log display area 102. Specifically, the log display area 102 additionally displays the nickname “AAA” and the chat log data “I′m free on the following days.” under the previously-displayed chat log data.

The shared information manager 67 of the client computer 3-1 displays the shared information received in step S74 in the shared-information window 111 displayed on the monitor 71 of the client computer 3-1.

The chat log manager 68 refers to the shared information ID attached to the chat log data stored in the storage unit 72 in step S74, searches for a shared-information window displaying the shared information with the same shared information ID (the shared-information window 111 in FIG. 10), and displays a link arrow 142 heading from a link word 141 to the shared-information window 111 (FIG. 10).

As discussed above, since the link arrow 142 heading from the link word 141 towards the shared-information window 111 is displayed, the user understands at a glance the association between each piece of chat log data and the corresponding shared information even when a plurality of pieces of chat log data are displayed in the log display area 102.

In steps S81 and S82, the client computer 3-2 performs processing similar to that performed by the client computer 3-1 in steps S74 and S75.

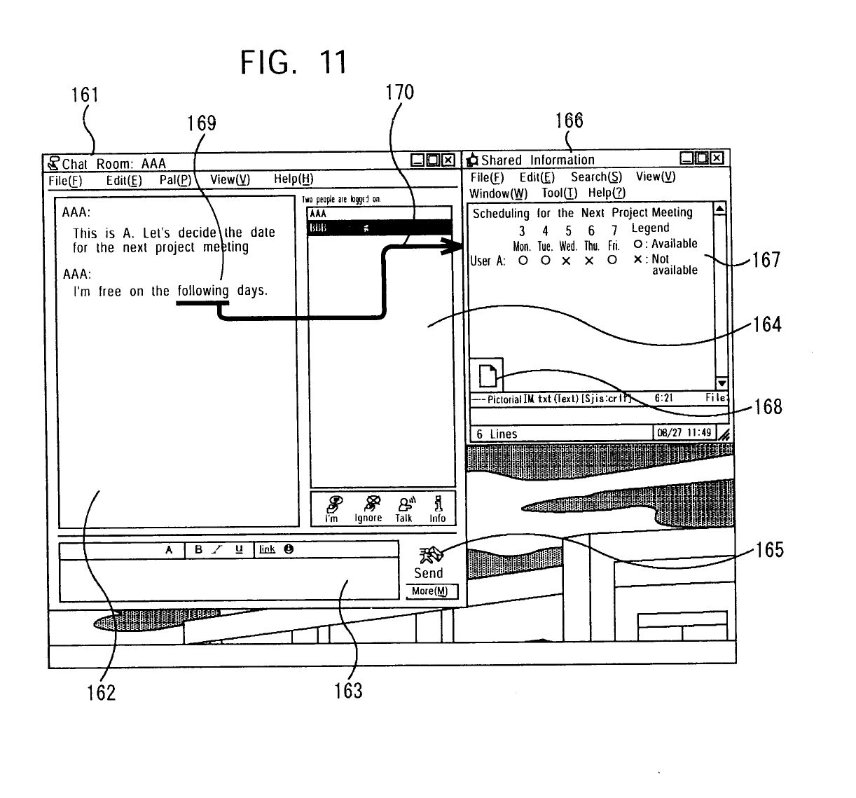

FIG. 11 shows an example of an image displayed on the monitor 71 of the client computer 3-2 in step S81. As shown in FIG. 11, a log display area 162 of a chat window 161 displays the same chat log data as that displayed in the log display area 102 of the client computer 3-1 shown in FIG. 10. A shared-information display area 167 of a shared-information window 166 shown in FIG. 11 displays the same shared information as that displayed in the shared-information display area 112 of the client computer 3-1 shown in FIG. 10.

As shown in FIG. 11, a link arrow 170 heading from a link word 169 “following” of the chat log data “I′m free on the following days.” displayed in the log display area 162 towards the shared-information window 166 is displayed. This is the same as the image displayed on the monitor 71 of the client computer 3-1 shown in FIG. 10.

User A can add information to or delete information from the shared information displayed in the shared-information display area 112 shown in FIG. 10. Also, user B can add information to or delete information from the shared information shown in the shared-information display area 167 shown in FIG. 11.

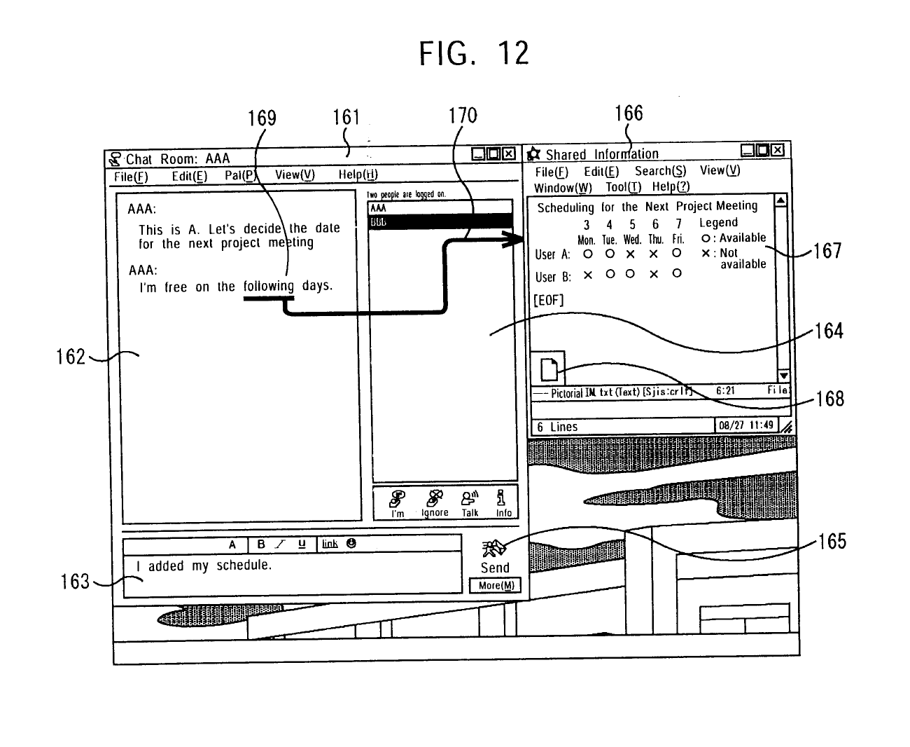

For example, in the monitor display state shown in FIG. 11, user B adds his/her schedule (◯ and x) in the shared-information display area 167 and the chat text “I added my schedule.” in an input area 163 of the chat window 161. FIG. 12 shows an example of an image displayed on the monitor 71 of the client computer 3-2 at this point.

As shown in FIG. 12, the schedule of user B (◯ and x) is added in the shared-information display area 167, and the chat text “I added my schedule.” is written in the input area 163 of the chat window 161.

When user B clicks on a send key 165 in this state, the shared information manager 67 of the client computer 3-2 attaches the shared information ID included in the shared information received in step S81 to the shared information having the information added thereto.

Subsequently, the chat input manager 66 supplies the chat text input in the input area 163 to the communication unit 73, and the shared information manager 67 supplies the shared information having the shared information ID attached thereto to the communication unit 73. The communication unit 73 attaches the chat room ID to the supplied chat text and shared information and sends the chat text and the shared information via the network 1 to the server 2.

The chat room manager 12 of the server 2 stores the chat text received from the client computer 3-2 in the chat log data management region for the chat room corresponding to the chat room ID in the database 13. The chat room manager 12 reads the shared information ID attached to the received shared information and determines whether or not shared information having the same shared information ID is stored in the shared information management region.

As a result, it is determined that the shared information ID of the shared information previously stored in the shared information management region in step S62 is the same as that of the currently received shared information. The chat room manager 12 deletes the shared information having the same shared information ID, which has been stored in the shared information management region, and, instead, stores the currently received shared information in the shared information management region.

Subsequently, the chat room manager 12 of the server 2 sends the chat log data stored in the chat log data management region and the shared information stored in the shared information management region to the client computers 3-1 and 3-2.

The client computers 3-1 and 3-2 receive the chat log data and the shared information from the server 2. Each chat log manager 68 stores the chat log data in the corresponding storage unit 72 and additionally displays the chat log data in the corresponding log display area. Each shared information manager 67 reads the shared information ID attached to the received shared information and determines whether or not shared information having the same shared information ID is stored in the corresponding storage unit 72.

As a result, it is determined that the shared information ID of the shared information previously stored in the storage unit 72 in step S74 (or step S81) is equivalent to that of the currently received shared information. Each shared information manager 67 deletes the shared information having the same shared information ID, which has been stored in the corresponding storage unit 72, and stores the currently received shared information in the storage unit 72. Subsequently, each shared information manager 67 displays the new shared information stored in the storage unit 72 in the shared-information display area in the shared-information window displayed on the corresponding monitor 71.

As discussed above, shared information displayed in the shared-information display area is edited by a plurality of clients (information is added thereto or deleted therefrom), and the shared information is updated at all times to the newest information.

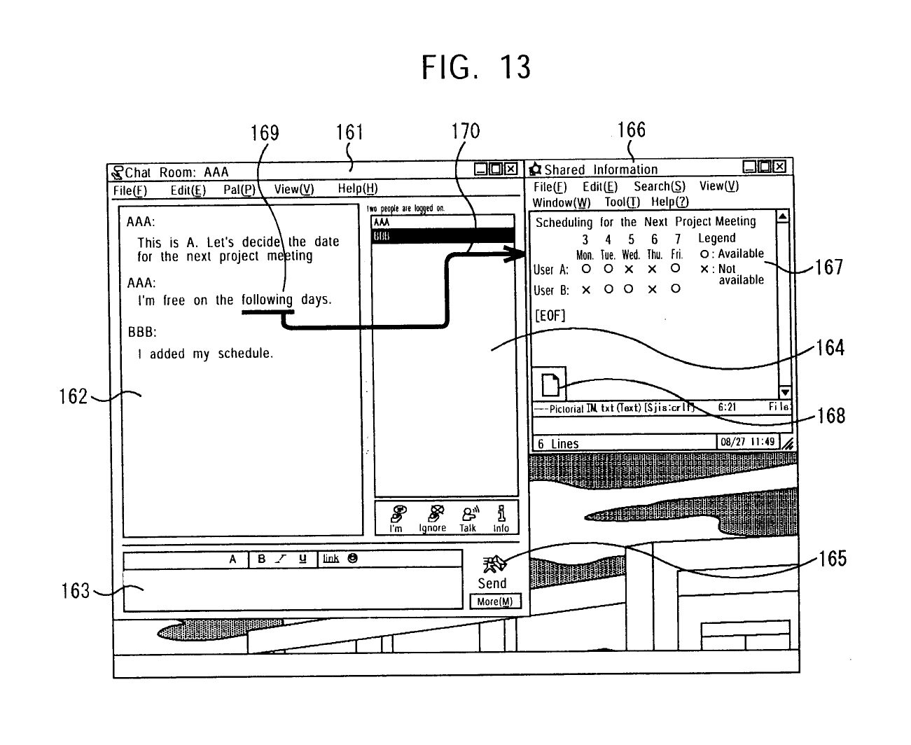

FIG. 13 shows an example of the updated shared information displayed on the monitor 71 of the client computer 3-2. As shown in FIG. 13, the fact that the link arrow 170 heading from the link word 169 towards the shared-information window 166 is displayed is the same as the image displayed on the monitor 71 of the client computer 3-2 prior to updating the shared information, as shown in FIG. 11.

Specifically, after the link arrow between the link word and the new shared-information window is displayed, even if information is added to or deleted from the shared information in the same shared-information window and the shared information is thus updated, the initial association between the link word and the shared-information window is maintained at the time the link arrow was first displayed.

When the image shown in FIG. 13 is displayed on the monitor 71, the user only inputs chat text in the input area 163, and no information is added to or deleted from the shared information displayed in the shared-information display area 167. When the user clicks on the send key 165 in this state, the shared information manager 67 determines that no information is added to or deleted from the shared information and thus does not send the shared information displayed in the shared-information display area 167 to the server 2.

Specifically, for example, when the image shown in FIG. 13 is displayed on the monitor 71, the chat text “Should we make it on the fourth (Tuesday)?” is input in the input area 163, and no information is added to or deleted from the shared information in the shared-information display area 167. In this case, the client computer 3-2 only sends the chat text to the server 2. The server 2 stores the received chat text as chat log data in the chat log data management region and, subsequently, sends the chat log data to the client computers 3-1 and 3-2. The client computers 3-1 and 3-2 display the chat log data received from the server 2 on the corresponding log display areas.

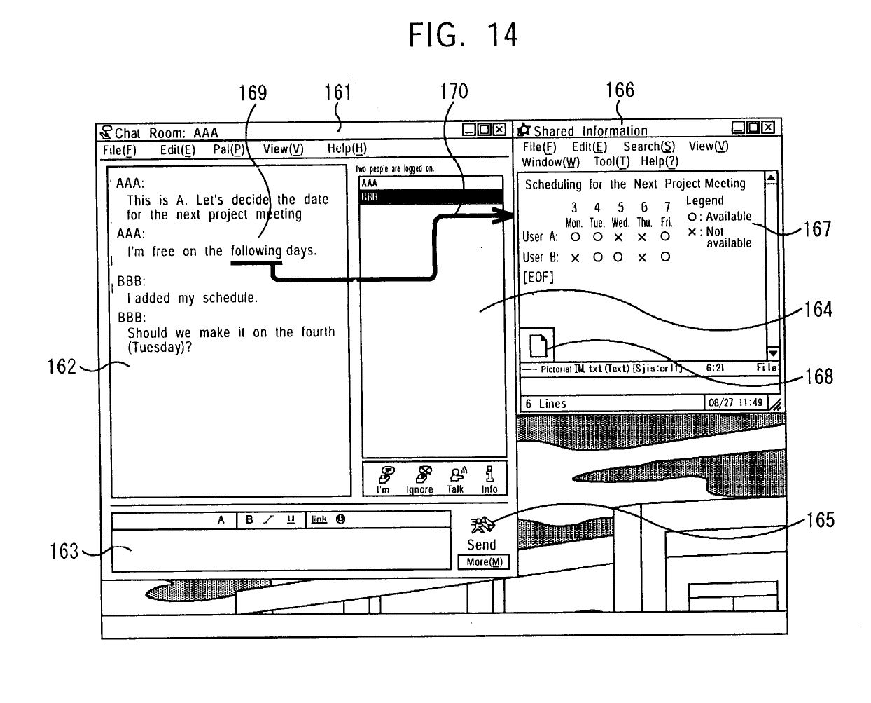

FIG. 14 shows an example of an image displayed on the monitor 71 of the client computer 3-2 at this point. As shown in FIG. 14, the log display area 162 displays the chat log data “Should we make it on the fourth (Tuesday)?”. The shared-information display area 167 displays the same shared information as that displayed in the shared-information display area 167 shown in FIG. 13.

As discussed above, only when information is added to or deleted from the shared information displayed in the shared-information display area, the shared information is sent to the server 2. Accordingly, the amount of information sent to the server 2 is reduced.

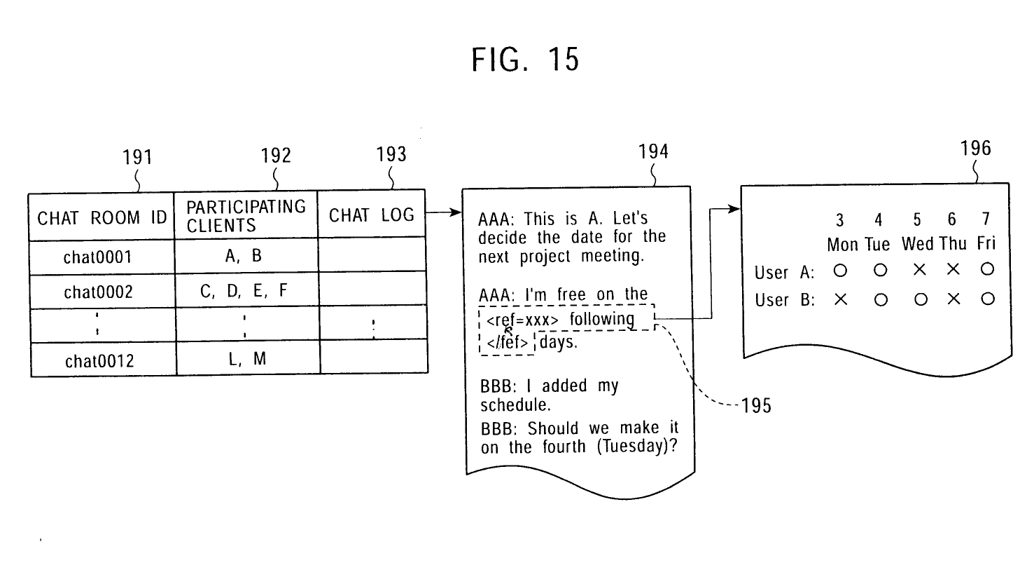

FIG. 15 schematically illustrates data managed in the database 13.

The server 2 can simultaneously manage a plurality of chat rooms. Referring to FIG. 15, the database 13 identifies and manages a plurality of chat rooms using unique chat room IDs 191. Specifically, FIG. 15 shows a case in which the chat room manager 12 of the server 2 simultaneously manages twelve different chat rooms whose chat room IDs range from chat0001 to chat0012. In FIG. 15, the chat room ID of the above-described chat room in which user A and user B participate is chat0001.

Under the category named “participating clients 192” shown in FIG. 15, members participating in the corresponding chat rooms (that is, logged-on user information) are managed in each chat room. Specifically, for example, the clients participating in the chat room with the chat room ID chat0001 are “A and B”, indicating user A and user B.

Under the category named “chat log 193” shown in FIG. 15, chat log data corresponding to each of the chat rooms from chat0001 to chat0012 is managed. For example, data managed in the chat room with the chat room ID chat0001 is shown in chat log data 194.

As shown in the chat log data 194, chat log data for a chat exchanged between the client computers 3-1 and 3-2 is stored in the chat log 193. In the chat log data 194, a link instruction 195 surrounded by a dotted line, that is, “<ref.xxx> following </ref>”, indicates that the surrounded word is a link word. As indicated by the link instruction 195, the chat room manager 12 links the chat log data with shared information 196 designated to be linked therewith and stores the chat log data in the database 13.

In the above description, an example of a chat between two computers, namely, the client computers 3-1 and 3-2, is illustrated. In a case of a chat involving three or more client computers 3, the processing performed by the client computers 3 and the server 2 is similar to that in a case of the above-described chat involving two client computers 3.

The processing of the client computer 3-3 and the server 2 in a case in which the client computer 3-3 participates in an on-going chat between the client computers 3-1 and 3-2 in the middle of the chat will now be described.

The chat room manager 12 of the server 2 receives, from the client computer 3-3, a notification of request for participation in an on-going chat performed between the client computers 3-1 and 3-2. The chat room manager 12 reads chat log data and shared information exchanged between the client computers 3-1 and 3-2 up to that time from the database 13 and sends the read data via the communication unit 11 to the client computer 3-1.

The client computer 3-3 receives the chat log data and the shared information from the server 2 and stores the received data and information in the storage unit 72. The chat log manager 68 of the client computer 3-3 displays a chat window formed of a log display area, an input area, and a user-list display area 215 on the monitor 71 and displays the chat log data stored in the storage unit 72 in the log display area. The shared information manager 67 of the client computer 3-3 displays a shared-information window on the monitor 71 and displays the shared information stored in the storage unit 72 in the shared-information window.

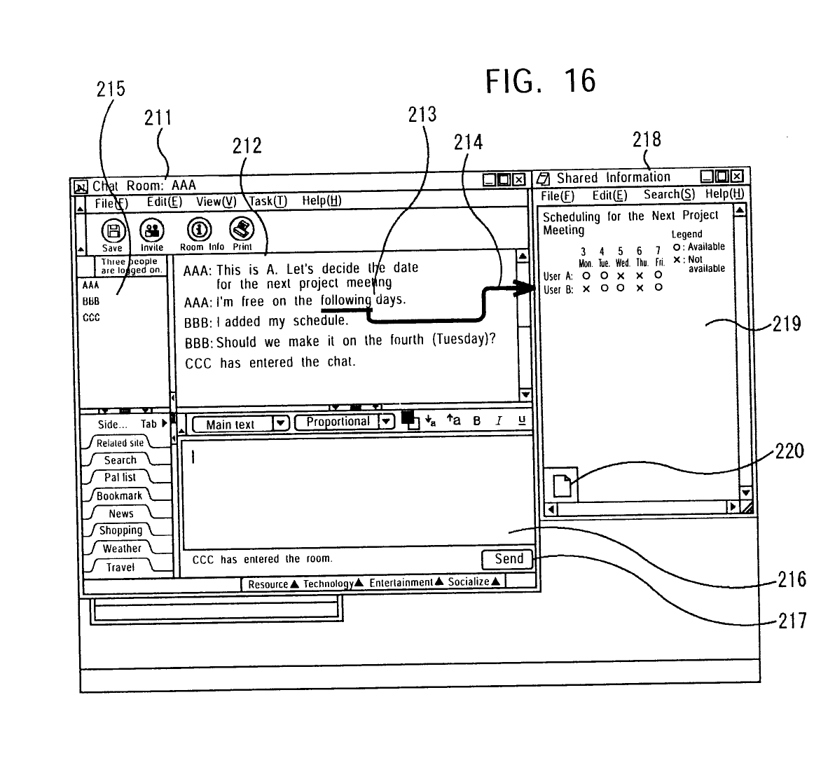

FIG. 16 shows an example of an image displayed on the monitor 71 of the client computer 3-3 participating in the on-going chat in the middle of the chat.

Referring to FIG. 16, a chat window 211 is displayed at the left, and a shared-information window 218 is displayed at the right. A log display area 212 in the chat window 211 displays the chat log data exchanged between user A and user B up to that time (the chat log data 194 in FIG. 15). A shared-information display area 219 in the shared-information window 218 displays the most recent shared information exchanged between user A and user B.

As discussed above, the monitor 71 of the client computer 3-3 displays the details of the chat performed between the client computers 3-1 and 3-2 up to that time (chat log data and shared information).

In a known chat, it is difficult for a user who participates in an on-going chat in the middle of the chat to understand the details of conversation in the chat up to that time unless the user reads the conversation (chat log data) displayed in the log display area from the beginning.

In contrast, in the system according to the present invention, as described in the above example, the main point of conversation conducted in the log display area between user A and user B (users' schedules in this example) is written in the shared-information window. This enables user C, who is the user of the client computer 3-3, to understand at a glance the details of conversation conducted between user A and user B by looking at information (schedules of user A and user B) in the shared-information window 218 displayed on the monitor 71 even if user C participates in the on-going chat in the middle of the chat.

As shown in FIG. 16, since a link word 213 and a link arrow 214 are displayed on the monitor 71, user C understands the details of conversation in the chat up to that time more easily.

The processing of the client computers 3-1 to 3-3 and the server 2 in a case of a chat involving three or more client computers 3 will now be described.

If a chat involves three or more client computers 3, the processing performed by the server 2 and each client computer 3 is similar to that in a case of a chat involving two client computers 3, which is described with reference to the flowchart of FIG. 7.

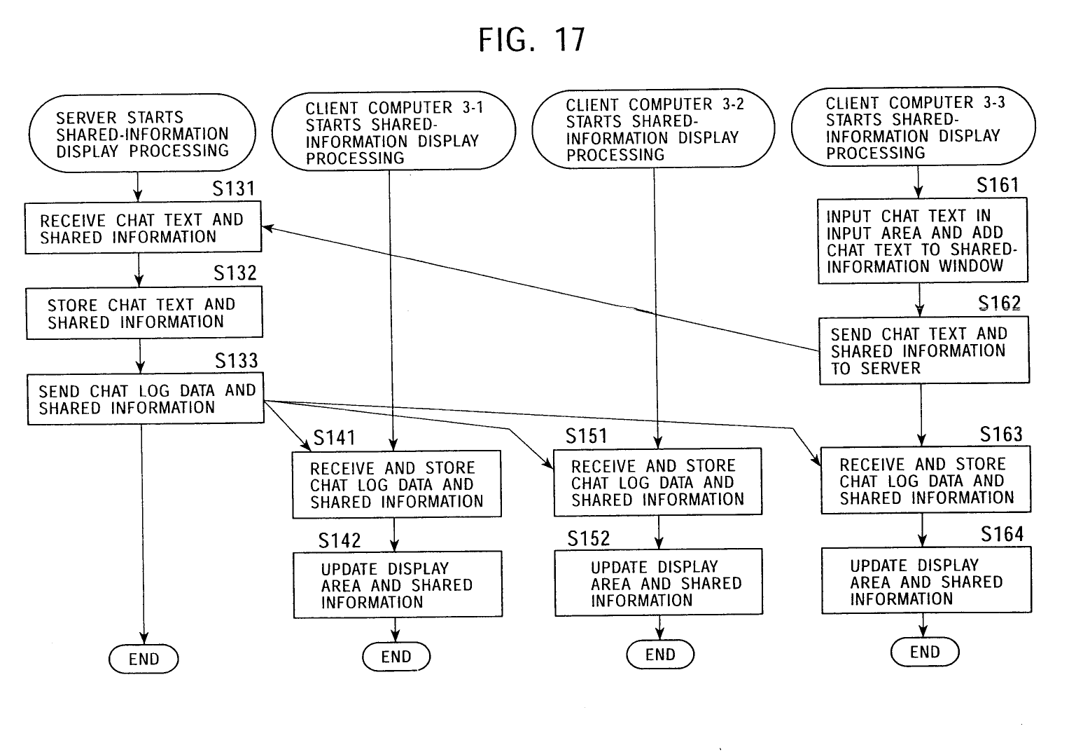

Referring to FIG. 17, the processing of the client computers 3-1 to 3-3 and the server 2 in a case of a chat involving the client computers 3-1 to 3-3 will now be described.

In step S161, for example, user C inputs the chat text “I added my schedule, too. Please arrange the date.” in an input area 216 on the monitor 71 of the client computer 3-3 shown in FIG. 16, adds information (e.g., the schedule of user C) in the shared-information display area 219, and clicks on a send key 217. The process proceeds to step S162, and the client computer 3-3 sends the input chat text and shared information to the server 2.

In step S131, the server 2 receives the chat text and the shared information sent from the client computer 3-3 in step S162. In step S132, the server 2 stores the received chat log data and shared information in predetermined regions of the database 13.

In step S133, the server 2 sends the chat log data and the shared information stored in the database 13 in step S132 to the client computers 3-1 to 3-3.

The client computers 3-1, 3-2, and 3-3 receive the chat text and the shared information from the server 2 and stores the received data in the corresponding storage units 72 in steps S141, S151, and S161, respectively.

The client computers 3-1, 3-2, and 3-3 display the received chat text and shared information on the corresponding monitors 71 in steps S142, S152, and S162, respectively.

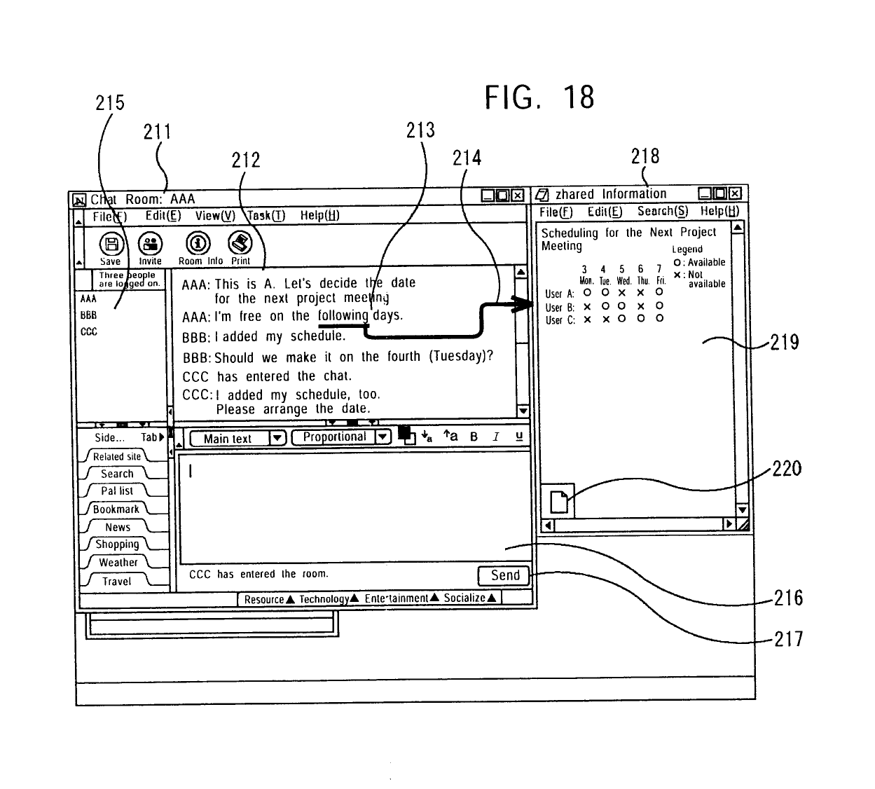

FIG. 18 shows an example of an image displayed on the monitor 71 of the client computer 3-3 in step S164.

Referring to FIG. 18, the log display area 212 of the chat window 211 additionally displays the chat log data “I added my schedule data, too. Please arrange the date”. In the shared-information display area 219 of the shared-information window 218, the schedule of user C (◯ and x) is added.

As discussed above, in the chat involving three or more client computers, as in the chat involving two client computers, the chat text (chat log data) and shared information are sent/received between the client computers 3 and the server 2.

In the chat performed by the above-described client computers 3-1 to 3-3, the processing of the client computers 3 and the server 2 in the chat system according to the present invention is described using a case of schedule adjustment. Writing the main point of conversation in the shared-information window allows communication to be performed more smoothly.

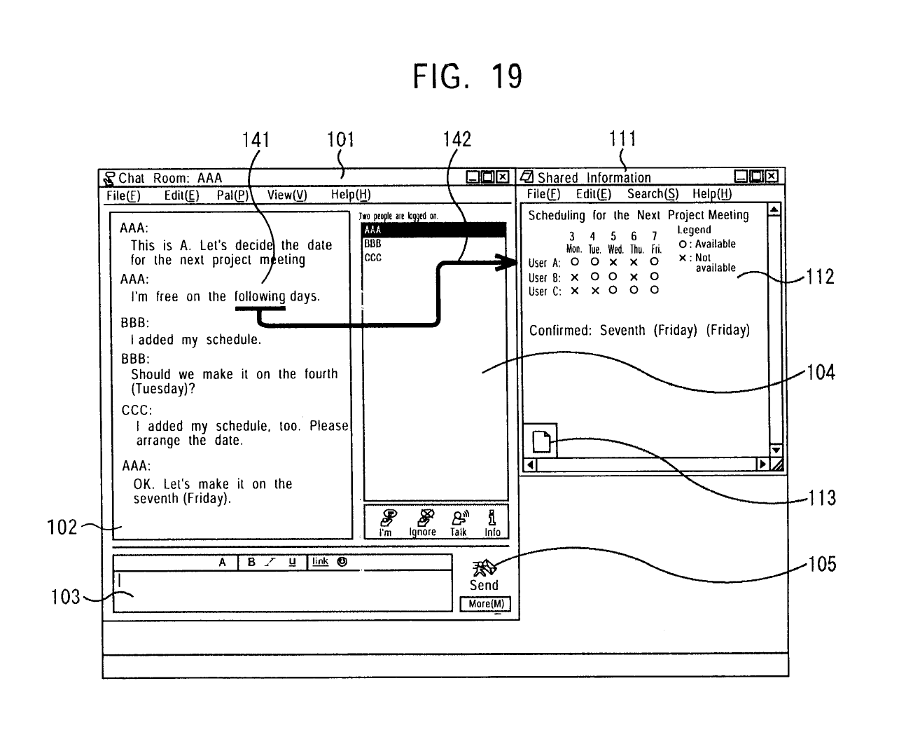

FIG. 19 shows an example of an image displayed on the monitor 71 of the client computer 3-1 after the chat log data is added and the information is added to the shared information by user A in the above case of schedule adjustment. Specifically, referring to FIG. 19, the log display area 102 displays chat log data input from user A, that is, “OK. Let's make it on the seventh (Friday)”, and the shared-information display area 112 in the shared-information window 111 additionally displays “Confirmed: seventh (Friday)”.

As discussed above, communication is performed in a conversation-like manner in the log display area 102, and the main point is summarized in the shared-information window 111. Accordingly, the users can easily exchange their opinions without seeing and talking to one another in person.

In the above-described case, only text data is handled as shared information. Other possible types of shared information include graphs, tables, and other image data. In the above-described case, a case in which one shared-information window is displayed is described. Alternatively, a plurality of shared-information windows may be displayed.

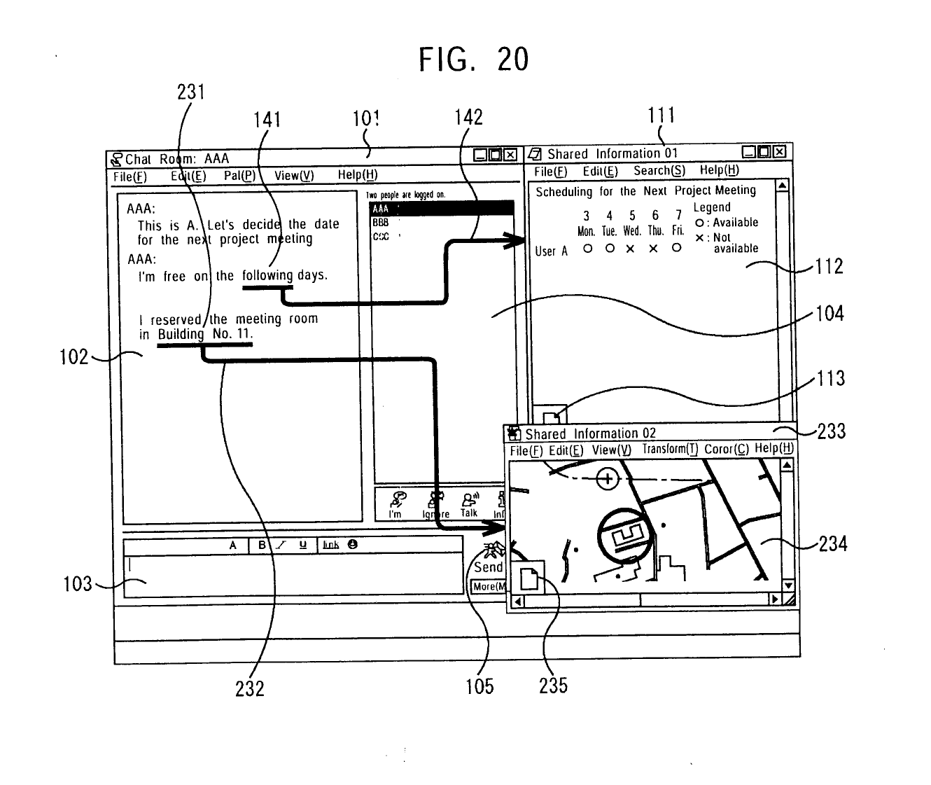

FIG. 20 shows an example of a case in which image data (map) serving as shared information is displayed in conjunction with a plurality of shared-information windows on the monitor 71 of the client computer 3-1.

Specifically, referring to FIG. 20, two shared-information windows, namely, the shared-information window 111 and a shared-information window 233, are displayed on the monitor 71. A shared-information display area 234 in the shared-information window 233 displays the image data (map).

The link arrow 142 heading from the link word 141 towards the shared-information window 111 is displayed, and a link arrow 232 heading from a link word 231 towards the shared-information window 233 is displayed.

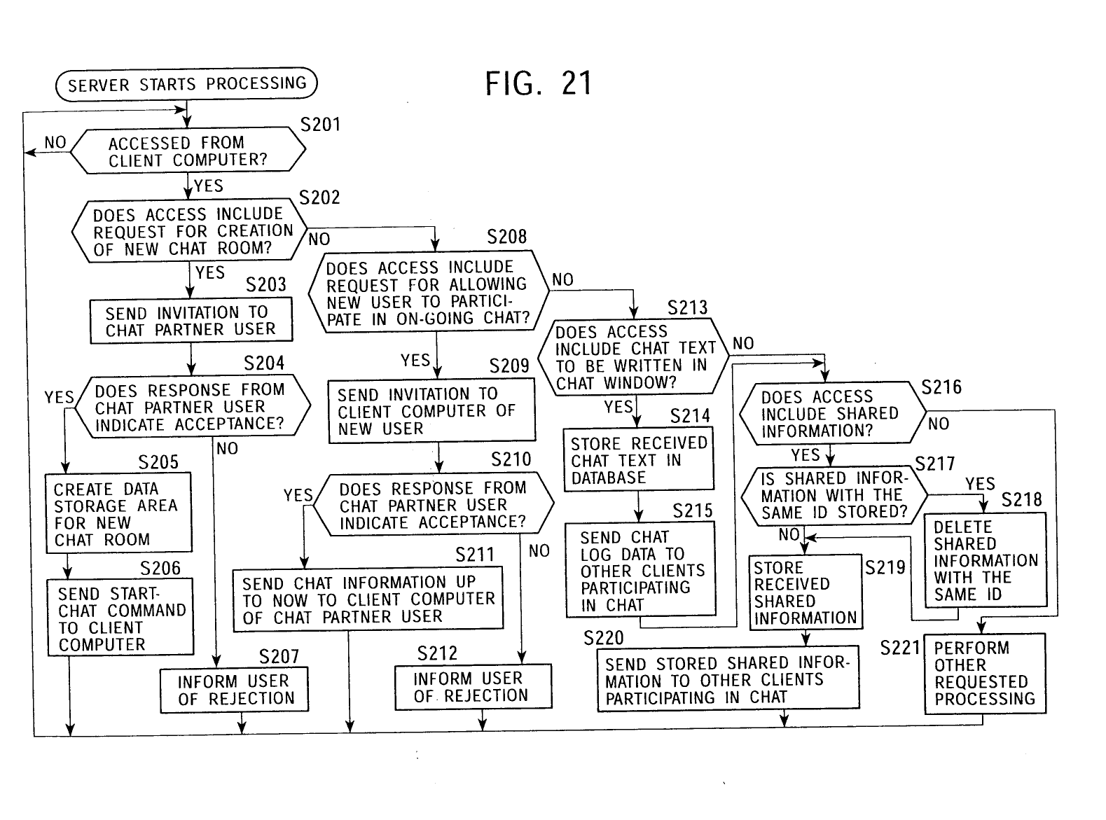

With reference to the flowchart of FIG. 21, a process performed by the server 2 for implementing the above-described operation will now be described.

In step S201, the CPU 31 of the server 2 continuously monitors the access to the communication unit 11 by each client computer 3. When the client computer 3 accesses the communication unit 11, the process proceeds to step S202.

In step S202, the chat room manager 12 analyzes the details of the access by the client computer 3 and determines whether or not the access includes a request for creation of a new chat room. If the access includes a request for creation of a new chat room, in step S203, the chat room manager 12 reads the nickname of a desired chat partner, which is included in the information sent from the client computer 3, and sends an invitation to a chat to the client computer 3 operated by the user having the detected nickname.

When a response to the invitation is sent from the client computer 3 to which the invitation has been sent, in step S204, the chat room manager 12 determines whether or not the response indicates the acceptance of the chat invitation. If the response indicates the acceptance of the chat invitation, in step S205, the chat room manager 12 creates a new storage region identified by a chat room ID in the database 13 (step S4 in FIG. 4).

In step S206, the chat room manager 12 sends an instruction via the communication unit 11 to each of plural client computers 3 starting chatting in the new chat room to display a chat window on the monitor 71. Subsequently, the process returns to step S201.

When the chat room manager 12 determines in step S204 that the response from the client computer 3 to which the invitation has been sent indicates the rejection of the chat invitation, in step S207, the chat room manager 12 informs the client computer 3 that has sent the request for creation of the new chat room of the rejection of the chat invitation from the desired chat partner (user). Subsequently, the process returns to step S201.

If it is determined in step S202 that the access by the client computer 3 includes no request for creation of a new chat room, the process proceeds to step S208.

In step S208, the chat room manager 12 determines whether the access from the client computer 3 includes an invitation to an on-going chat room to a new user. If it is determined that the access includes an invitation to a new user, in step S209, the chat room manager 12 detects the nickname of a desired chat partner (new user), which is included in the information sent from the client computer 3, and sends an invitation to the chat having a chat-room name attached thereto to the client computer 3 operated by the user with the detected nickname.

When a response to the invitation is sent from the client computer 3 to which the invitation has been sent, in step S210, the chat room manager 12 determines whether or not the response indicates the acceptance of the chat invitation. If the response indicates the acceptance of the chat invitation, in step S211, the chat room manager 12 sends chat log data and shared information related to the chat, which have been stored in the database 13 and which have been exchanged in the chat room up to that time, to the client computer 3 operated by the new user. Subsequently, the process returns to step S201.

If it is determined in step S210 that the response from the client computer 3 to which the invitation has been sent indicates the rejection of the chat invitation, in step S212, the client computer 3 having sent the chat invitation is informed of the rejection of the chat invitation from the desired chat partner (new user). Subsequently, the process returns to step S201.

If the chat room manager 12 determines in step S208 that the access from the client computer 3 includes no invitation to an on-going chat room to a new user, in step S213, the chat room manager 12 determines whether or not the access from the client computer 3 includes chat log data, thus determining whether or not the access from the client computer 3 includes chat log data to be written in the chat window.

As a result, if the access from the client computer 3 includes chat log data, the chat room manager 12 determines that the access from the client computer 3 includes chat log data to be written in the chat window. In step S214, the chat room manager 12 stores the received chat log data in the database 13.

As shown in FIG. 15, the chat log data is stored in the chat log 193 having the corresponding chat room ID. When the chat log data includes a shared information ID attached thereto, the shared information ID is also stored in conjunction with the chat log data.

In step S215, the chat room manager 12 sends the chat log data stored in the database 13 in step S214 via the communication unit 11 to all client computers 3 participating in the same chat room.

If the access from the client computer 3 includes no chat lot data in step S213, or if the processing in step S215 is completed, in step S216, the chat room manager 12 determines whether or not the access from the client computer 3 includes shared information. If the access includes shared information, the process proceeds to step S217.

In step S217, the chat room manager 12 reads the shared information ID of the shared information and the chat room ID included in the access from the client computer 3 and determines whether or not shared information having the same shared information ID as the read shared information ID is stored in the shared information management region in a chat room corresponding to the read chat room ID. As a result, when shared information having the same shared information ID is already stored in the shared information management region, in step S218, the chat room manager 12 deletes the shared information having the same shared information ID, which has been stored in the shared information management region.

When the chat room manager 12 determines in step S217 that no shared information having the same shared information ID as that of the shared information received from the client computer 3 is stored in the shared information management region, or when the processing in step S218 is completed, the process proceeds to step S219.

In step S219, the chat room manager 12 stores the shared information received from the client computer 3 in the shared information management region in the database 13.

In step S220, the chat room manager 12 sends the shared information stored in the database 13 in step S219 to all the other client computers 3 chatting in the same chat room. Subsequently, the process returns to step S201.

If the chat room manager 12 determines in step S216 that the access from the client computer 3 includes no shared information, in step S221, the chat room manager 12 performs predetermined processing in accordance with an instruction included in the access from the client computer 3. The process returns to step S201.

The server 2 performs the above-described process to manage the client computers 3 performing chatting.

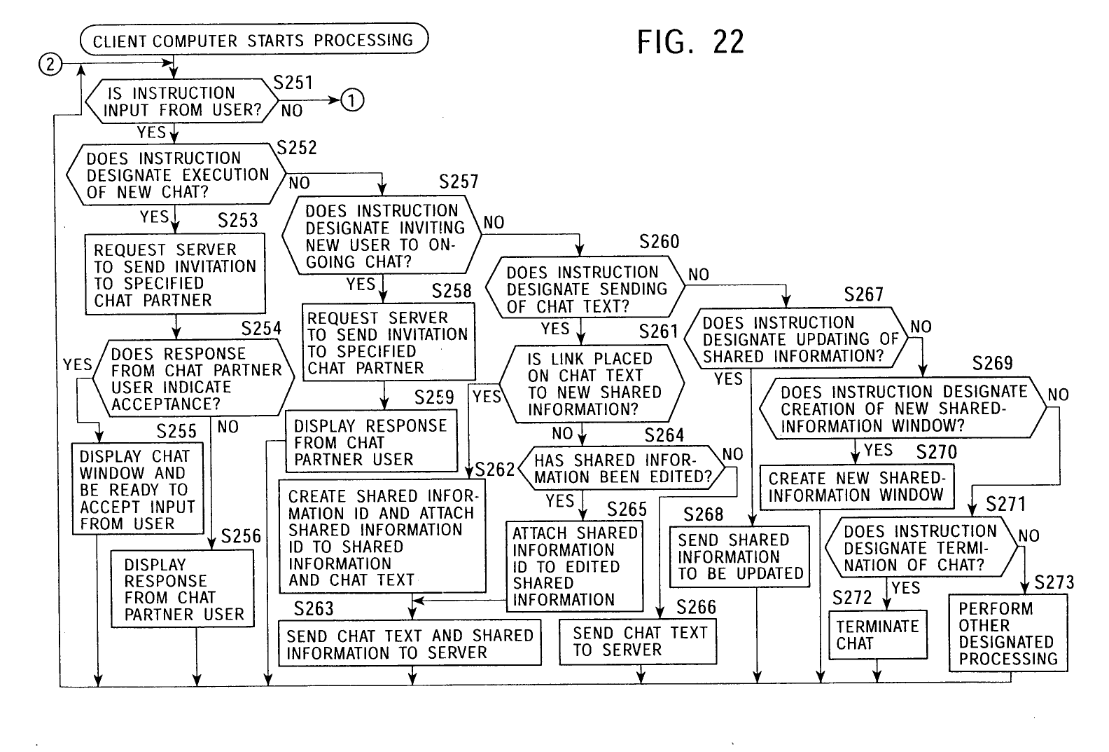

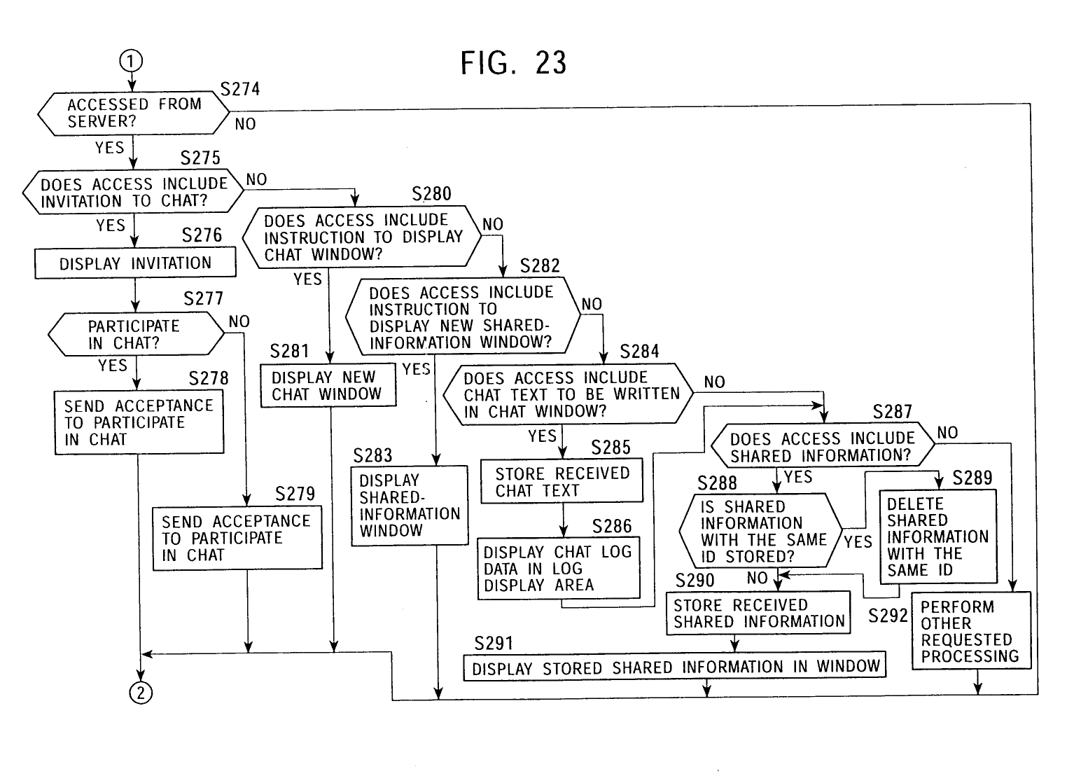

With reference to FIGS. 22 and 23, a process performed by each client computer 3 for implementing the above-described operation will now be described.

In step S251, the CPU 61 of each client computer 3 determines whether or not an instruction is input from a User via the input unit 69. If an instruction is input from the input unit 69, in step S252, the CPU 61 determines whether or not the instruction from the user designates execution of a new chat.

As a result, if the instruction from the user designates execution of a new chat, in step S253, the CPU 61 requests the server 2 via the communication unit 73 to send an invitation to a specified chat partner.

When a response from the specified chat partner is received from the server 2, in step S254, the CPU 61 determines whether or not the response from the specified chat partner indicates the acceptance of the chat invitation. If the response from the specified chat partner indicates the acceptance of the chat invitation, in step S255, the CPU 61 displays a chat window on the monitor 71 in accordance with an instruction from the server 2.

If the CPU 61 determines in step S254 that the response from the specified chat partner indicates the rejection of the chat invitation, in step S256, the CPU 61 displays on the monitor 71 a guidance message indicating that the specified chat partner to which the invitation has been sent does not want to chat. Subsequently, the process returns to step S251.

If the CPU 61 determines in step S252 that the instruction from the user does not designate execution of a new chat, in step S257, the CPU 61 determines whether or not the instruction from the user designates inviting a new user to an on-going chat room in which the user and another user are already chatting. If the instruction from the user designates inviting a new user to an on-going chat room in which the user and another user are already chatting, the process proceeds to step S258.

In step S258, the CPU 61 requests the server 2 via the communication unit 73 to send an invitation to a specified chat partner (a user who is not participating in the on-going chat and who is specified by operating the input unit 69 from among users displayed in the user-list area).

Subsequently, when a response is sent from the user to which the invitation has been sent, in step S259, the CPU 61 displays the response from the invited user on the monitor 71. Specifically, whether the response from the invited user indicates the acceptance or rejection of the chat invitation is displayed on the monitor 71.

When the CPU 61 determines in step S257 that the instruction from the user does not designate inviting a new user to an on-going chat room in which the user and another user are already chatting, the process proceeds to step S260.

In step S260, the CPU 61 determines whether or not the instruction from the user designates sending of chat text. Specifically, for example, as shown in FIG. 5, when the character string “This is A. Let's decide the date for the next project meeting.” is input in the input area 103, it is determined whether the send key 105 is clicked (or Enter key is operated).

As a result, when the CPU 61 determines that the instruction from the user designates sending of chat text, in step S261, the chat input manager 66 determines, in response to a command from the CPU 61, whether or not a link to new shared information is placed on the chat text input in the input area 103. When a link to new shared information is placed on the character string input in the input area 103, in step S262, the shared information manager 67 creates, in response to a command from the CPU 61, a shared information ID of the shared information displayed in the shared-information window and attaches the shared information ID to the shared information. Also, the shared information manager 67 supplies the shared information ID to the chat input manager 66. The chat input manager 66 attaches the shared information ID supplied from the shared information manager 67 to the chat text.

In step S263, in response to a command from the CPU 61, the chat input manager 66 supplies the chat text input in the input area 103 to the communication unit 73, and the shared information manager 67 supplies the shared information to the communication unit 73. The communication unit 73 sends the supplied chat text and shared information to the server 2.

Subsequently, the process returns to step S251.

If the chat input manager 66 determines in step S261 that no link to new shared information is placed on the chat text input in the input area 103, in step S264, in response to a command from the CPU 61, the shared information manager 67 determines whether or not information is added to or deleted from the shared information displayed in the shared-information display window. If it is determined that information is added to or deleted from the shard information displayed in the shared-information window, in step S265, the shared information manager 67 reads the shared information ID attached to the shared information prior to the addition or deletion of information and attaches the read shared information ID to the shared information after the addition or deletion of information. Subsequently, the process proceeds to step S263, and the above-described processing is repeated.

When the shared information manager 67 determines in step S264 that no information is added to or deleted from the shared information displayed in the shared-information window (or when no shared-information window is displayed on the monitor 71), in step S266, in response to a command from the CPU 61, the chat input manager 66 sends the chat text input in the input area 103 via the communication unit 73 to the server 2.

Subsequently, the process returns to step S251. If the CPU 61 determines in step S260 that the instruction from the user does not designate sending of chat text, the process proceeds to step S267.

In the chat system according to the present invention, chatting users may only send shared information. In this case, information displayed in the chat window is not updated, and only information displayed in the shared-information window is updated.

In step S267, the CPU 61 determines whether or not the instruction from the user designates updating of shared information already displayed in the shared-information window.

As a result, if the CPU 61 determines that the instruction from the user designates updating of shared information already displayed in the shared-information window, in step S268, the CPU 61 sends the shared information displayed in the specified shared-information window to the server 2. Subsequently, the process returns to step S251.

If the CPU 61 determines in step S267 that the instruction from the user does not designate updating of shared information already displayed in the shared-information window, in step S269, the CPU 61 determines whether or not the instruction from the user designates creation of a new shared-information window. If the instruction from the user designates creation of a new shared-information window, in step S270, in response to a command from the CPU 61, the shared information manager 67 displays a new shared-information window on the monitor 71. Subsequently, the process returns to step S251.

If the CPU 61 determines in step S269 that the instruction from the user does not designate creation of a new shared-information window, in step S271, the CPU 61 determines whether or not the instruction from the user designates termination of a chat. If it is determined that the instruction from the user designates termination of a chat, in step S272, the CPU 61 terminates an on-going chat. Subsequently, the process returns to step S251.

When a plurality of users remain in the chat room after the chat is terminated by one client computer 3, the remaining users can continue chatting.

If the CPU 61 determines in step S271 that the instruction from the user does not designate termination of a chat, in step S273, the CPU 61 performs processing other than that described above in accordance with the instruction from the user.

If the CPU 61 determines in step S251 that no instruction is input from the user, the process proceeds to step S274 of FIG. 23.

In step S274, the CPU 61 determines whether or not the communication unit 73 has received information sent from the server 2. If information sent from the server 2 is received, the process proceeds to step S275.

In step S275, the CPU 61 determines whether or not the access from the server 2 includes an invitation to a chat. If the access from the server 2 includes an invitation to a chat, in step 276, the CPU 61 displays on the monitor 71 an invitation (for example, a message such as “You have received an invitation to a chat from user A. Do you want to accept the invitation? (Yes or No)”).

The user can select whether to participate in the chat using the input unit 69. In step S277, the CPU 61 determines whether the selection input by the user is the acceptance of the chat invitation. If the selection input by the user is the acceptance of the chat invitation, in step S278, the CPU 61 sends information indicating that the user wants to participate in the chat via the communication unit 73 to the server 2.

If the CPU 61 determines in step S277 that the selection input by the user is not the acceptance of the chat invitation, in step S279, the CPU 61 sends information indicating that the user does not want to participate in the chat via the communication unit 73 to the server 2.

If the CPU 61 determines in step S275 that the access from the server 2 includes no chat invitation, the process proceeds to step S280.

In step S280, the CPU 61 determines whether or not the access from the server 2 includes an instruction to display a chat window on the monitor 71. If it is determined that the access from the server 2 includes an instruction to display a chat window on the monitor 71, in step S281, in response to a command from the CPU 61, the chat log manager 68 displays a chat window on the monitor 71. Subsequently, the process returns to step S251.

If the CPU 61 determines that the access from the server 2 includes no instruction to display a chat window on the monitor 71, the process proceeds to step S282.

In step S282, the CPU 61 determines whether or not the access from the server 2 includes an instruction to display a new shared-information window on the monitor 71. If it is determined that the access from the server 2 includes an instruction to display a new shared-information window on the monitor 71, in step S283, in response to a command from the CPU 61, the chat log manager 68 displays a new shared-information window on the monitor 71. Subsequently, the process returns to step S251.

If the CPU 61 determines that the access from the server 2 includes no instruction to display a new shared-information window on the monitor 71, the process proceeds to step S284.

In step S284, in response to a command from the CPU 61, the chat log manager 68 determines whether or not the access from the server 2 includes chat log data. Accordingly, it is determined whether or not the access from the server 2 includes chat log data to be written in the chat window.

As a result, if the access from the server 2 includes chat log data, the chat log manager 68 determines that the access from the server 2 includes chat log data to be written in the chat window. In step S285, the chat log manager 68 stores the received chat log data in the storage unit 72.

If the chat log data includes a shared information ID attached thereto, the shared information ID is also stored in conjunction with the chat log data.

In step S286, the chat log manager 68 displays the chat log data stored in the storage unit 72 in step S285 at a predetermined position in the log display area displayed on the monitor 71.

If it is determined in step S284 that the access from the server 2 includes no chat log data, or if the processing in step S286 is completed, the process proceeds to step S287. In response to a command from the CPU 61, the shared information manager 67 determines whether or not the access from the server 2 includes shared information. If the access from the server 2 includes shared information, the process proceeds to step S288.

In step S288, the shared information manager 67 determines whether or not shared information having the same shared information ID as that of the shared information included in the access from the server 2 is stored in the storage unit 72. As a result, if shared information having the same shared information ID is already stored in the storage unit 72, in step S289, the shared information manager 67 deletes the shared information having the same shared-information ID, which has been stored in the storage unit 72.

If the shared information manager 67 determines in step S288 that no shared information having the same shared-information ID as that of the shared information received from the server 2 is stored in the storage unit 72, or if the processing in step S289 is completed, the process proceeds to step S290.

In step S290, the shared information manager 67 stores the shared information received from the server 2 in the storage unit 72.

In step S291, the shared information manager 67 displays the shared information stored in the storage unit 72 in step S290 in the shared-information window.

If the chat log data displayed in step S286 in the log display area in the chat window has a shared-information ID attached thereto, when the shared information manager 67 displays in step S291 the shared information in the shared-information window, the chat log manager 68 displays a link arrow heading from the chat log data displayed in the log display area towards the shared-information window.

Subsequently, the process returns to step S251.

If the shared information manager 67 determines in step S287 that the access from the server 2 includes no shared information, in step S292, the CPU 61 performs predetermined processing in accordance with an instruction included in the access from the server 2. Subsequently, the process returns to step S251.

The client computer 3 performs the above-described process to provide a chat environment to the user.

In the above description, as described with reference to FIG. 8, a link is placed between chat text and a shared-information window by dragging and dropping the shared-information icon 113 in the shared-information window 111 onto the input area 103 in the chat window 101. There is another possible method for placing a link between chat text and a shared-information window, which will now be described.

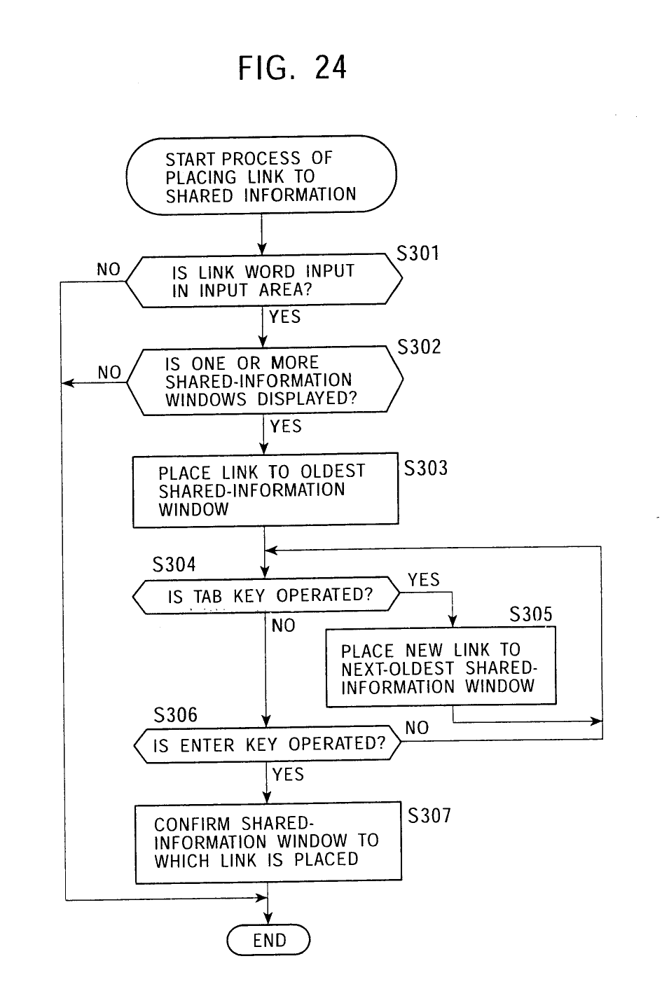

With reference to the flowchart of FIG. 24, another method (process) for placing a link between chat text and a shared-information window will now be described.

In step S301, the chat input manager 66 determines whether or not a link word (e.g., “following”) is input in an input area of a chat window. If no link word is input in the input area, the process is terminated.

If the chat input manager 66 determines in step S301 that a link word is input in the input area of the chat window, in step S302, the chat input manager 66 causes the shared information manager 67 to determine whether or not a shared-information window is displayed on the monitor 71.

If the shared information manager 67 determines in step S302 that no shared-information window is displayed on the monitor 71, the chat input manager 66 terminates the process.

If the shared information manager 67 determines in step S302 that a shared-information window is displayed on the monitor 71, in step S303, the chat input manager 66 requests the shared information manager 67 to notify the chat input manager 66 of the oldest-displayed shared-information window of one or more shared-information windows displayed on the monitor 71.

In response to the request from the chat input manager 66, the shared information manager 67 notifies the chat input manager 66 of the oldest shared-information window displayed on the monitor 71.

On the basis of the notification from the shared information manager 67, the chat input manager 66 displays a link arrow (places a link) heading from the link word input in the input area towards the oldest shared-information window displayed on the monitor 71.

In step S304, the CPU 61 determines whether or not TAB key is operated. If it is determined that TAB key is operated, the process proceeds to step S305.

In step S305, in response to a command from the CPU 61, the chat input manager 66 requests the shared information manager 67 to notify the chat input manager 66 of the shared-information window that is next oldest to the currently linked shared-information window of one or more shared-information windows displayed on the monitor 71.

In response to the request from the chat input manager 66, the shared information manager 67 notifies the chat input manager 66 of the shared-information window that is next oldest to the currently-linked shared-information window.

On the basis of the notification from the shared information manager 67, the chat input manager 66 displays a link arrow (places a link) heading from the link word input in the input area towards the shared-information window that is next oldest to the currently-linked shared-information window.

If the CPU 61 determines in step S304 that TAB key is not operated, in step S306, the CPU 61 determines whether or not Enter key is operated. If it is determined that Enter key is not operated, the process returns to step S304, and the processing from step S304 onward is repeated.

If the CPU 61 determines in step S306 that Enter key is operated, in step S307, in response to a command from the CPU 61, the chat input manager 66 determines to place a link to the shared-information window specified by the link arrow. The process is thus completed.

As discussed above, a link to a shared-information window is placed at the time of inputting a link word. This enables a user to place a link to a shared-information window while keeping his/her mind on inputting chat text.

The user can set a predetermined word as a link word. The user can also store several words as link words in a chat client program.

Although the chat window and the shared-information window are arranged as independent windows in the above-described embodiment, the two windows may be combined to form one window.

Although the chat window and the shared-information window are displayed on the same monitor in the above-described embodiment, the windows may be displayed separately on a plurality of monitors.

Although the chat log data is text data in the above-described embodiment, the chat log data may include data other than text data, such as audio data. In this case, for example, the client computer 3 includes an audio input unit, and audio data input from the audio input unit is used.

Although the server 2 is described as an independent unit in the above-described example, the client computer 3 may include the function of the server 2. In this case, the client computers 3-1 to 3-3 each perform the function of the above-described client computer and the function of the above-described server. Specifically, for example, the client computer 3-1 may send chat log data and shared information, which are generated by the client computer 3-1, to the client computer 3-2 or the client computer 3-3. The client computer 3-1 may display chat log data and shared information sent from the client computer 3-2 or the client computer 3-3 on the monitor 71 of the client computer 3-1 and send the chat log data and the shared information to the client computer 3-2 or the client computer 3-3.

The above-described series of processes can be performed by hardware or software. In a case in which the series of processes is performed by software, a program forming the software is installed from a program storage medium into a computer (the CPU 31 shown in FIG. 2 or the CPU 61 shown in FIG. 3) incorporated in dedicated hardware or, for example, into a general personal computer capable of performing various functions by installing therein various programs.

The program storage medium having stored thereon a program to be installed in and executed by a computer is formed of, as shown in FIGS. 2 and 3, a package medium including the magnetic disks 41 and 75 (including flexible disks), the optical disks 42 and 76 (including CD-ROMs (Compact Disk-Read Only memory) and DVDs (Digital Versatile Disks)), the magneto-optical disks 43 and 77, or the semiconductor memories 44 and 78. The program is stored in the program storage medium using a wired or wireless communication medium, such as a local area network (LAN), the Internet, or digital satellite broadcasting, via an interface such as a router or a modem, if necessary.

In this specification, steps for writing the program provided by the medium are not necessarily processed in time series in the order described. Parallel processing or individual processing is also included.

In this specification, the system refers to the entirety of an apparatus formed of a plurality of apparatuses.

What is claimed is:

1. A server comprising:
a communication unit configured to receive both text chat related information and sharing related information from at least one client terminal of a plurality of client terminals;
a storage unit configured to store group information regarding a group to which the plurality of client terminals are registered; and
a controller configured to control the communication unit to transmit both the received text chat related information and sharing related information to a remaining number of the plurality of client terminals based on the group information,
wherein the communication unit receives, from at least one of the plurality of client terminals, and transmits, to a remaining number of the plurality of client terminals, graphical information, and
wherein the graphical information supplements a relationship between the text chat related information and the sharing related information displayed at the plurality of client terminals.

2. The server according to claim 1, wherein the text chat related information and sharing related information and the graphical information are received from the same at least one client terminal.

3. The server according to claim 1, wherein the graphical information is displayed between the text chat related information and the sharing related information at the plurality of client terminals.

4. The server according to claim 1, wherein the communication unit is controlled to transmit both the received text chat related information and sharing related information at the same time.

5. The server according to claim 1, wherein the sharing related information includes images.

6. A terminal comprising:
a communication unit configured to receive text chat related information and sharing related information from a server;
a controller configured to control a display unit to display the text chat information in a chat area and the sharing information in a sharing area,
wherein the communication unit receives graphical information from the server, and
wherein the controller controls the display unit to display the graphical information so that the graphical information supplements a relationship between the text chat related information and the sharing related information.

7. The terminal according to claim 6, wherein the communication unit is further configured to receive the text chat related information and the sharing related information from the server at the same time.

8. The terminal according to claim 7, wherein the communication unit is further configured to transmit newly generated text chat related information and sharing related information to the server.

9. The terminal according to claim 6, wherein the terminal is registered to a group to which a plurality of client terminals are registered.

10. The terminal according to claim 9, wherein the terminal and at least one of the plurality of client terminals receive the text chat related information and the sharing related information from the server.

11. The terminal according to claim 8, wherein the newly generated sharing related information includes images provided from the terminal.

12. The terminal according to claim 9, wherein the sharing related information includes images provided from at least one of the plurality of client terminals.

13. A method of distributing information using a server having a microprocessor, comprising:
receiving, at the server, both text chat related information and sharing related information from at least one client terminal of a plurality of client terminals;
storing group information regarding a group to which the plurality of client terminals are registered;
transmitting, from the server, both the received text chat related information and sharing related information to a remaining number of the plurality of client terminals based on the group information;
receiving, at the server and from at least one of the plurality of client terminals, graphical information;
transmitting, from the server and to a remaining number of the plurality client terminals, the graphical information, the graphical information supplementing a relationship between the text chat related information and the sharing related information displayed at the plurality of client terminals.

14. The method of distributing information according to claim 13, wherein the transmitting both the received text chat related information and the sharing relating information further comprises:
transmitting both the received text chat related information and sharing related information at the same time.

15. A method of receiving information using a terminal having a microprocessor, comprising:
receiving, at the terminal, text chat related information and sharing related information from a server;
displaying, on a display unit of the terminal, the text chat information in a chat area and the sharing information in a sharing area,
receiving, at the terminal, graphical information from the server, and
displaying, on the display unit of the terminal, the graphical information so that the graphical information supplements a relationship between the text chat related information and the sharing related information.

16. The method according to claim 15, wherein the receiving text chat related information and sharing related information further comprises:
receiving the text chat related information and the sharing related information from the server at the same time.

17. A non-transitory computer readable medium having stored thereon a program that when executed by a computer causes the computer to implement a method of distributing information, comprising:
Receiving both text chat related information and sharing related information from at least one client terminal of a plurality of client terminals;
storing group information regarding a group to which the plurality of client terminals are registered;
transmitting both the received text chat related information and sharing related information to a remaining number of the plurality of client terminals based on the group information;
receiving, from at least one of the plurality of client terminals, graphical information;
transmitting, to a remaining number of the plurality client terminals, the graphical information, the graphical information supplementing a relationship between the text chat related information and the sharing related information displayed at the plurality of client terminals.

18. The non-transitory computer readable medium according to claim 17, wherein the transmitting both the received text chat related information and the sharing relating information further comprises:
transmitting both the received text chat related information and sharing related information at the same time.

19. A non-transitory computer readable medium having stored thereon a program that when executed by a computer causes the computer to implement a method of receiving information, comprising:
receiving text chat related information and sharing related information from a server;
displaying the text chat information in a chat area and the sharing information in a sharing area,
receiving graphical information from the server, and
displaying the graphical information so that the graphical information supplements a relationship between the text chat related information and the sharing related information.

20. The non-transitory computer readable medium according to claim 19, wherein the receiving text chat related information and sharing related information further comprises:
receiving the text chat related information and the sharing related information from the server at the same time.
